(19) United States
(12) Patent Application Publication
(10) Pub. No.: US 2022/0335385 A1
(43) Pub. Date: Oct. 20, 2022

(54) SYSTEM AND METHOD FOR SYSTEMATIC PRESENTATION AND ORDERING OF DOCUMENTS BASED ON TRIGGERS

(71) Applicant: Procore Technologies, Inc., Carpinteria, CA (US)

(72) Inventor: Scott Gerard Wolfe, JR., New Orleans, LA (US)

(21) Appl. No.: 17/712,973

(22) Filed: Apr. 4, 2022

Related U.S. Application Data
(63) Continuation of application No. 15/284,455, filed on Oct. 3, 2016, now abandoned.
Application No. 15/284,455 is a continuation-in-part of application No. 14/104,430, filed on Dec. 12, 2013, now abandoned.
Application No. 14/104,430 is a continuation-in-part of application No. 13/490,781, filed on Jun. 7, 2012, now abandoned.
(60) Provisional application No. 62/235,745, filed on Oct. 1, 2015.

(51) Int. Cl. G06Q 10/10; G06Q 50/08; G06F 16/22; G06F 16/93; G06F 16/2455

(52) U.S. Cl. CPC G06Q 10/103; G06Q 50/08; G06F 16/22; G06F 16/93; G06F 16/24565; Y10T 29/49004; Y10T 29/49016

(57) ABSTRACT

A system and method for calculating and organizing a plurality of document objects with associated workflow objects for a plurality of user devices whereby a deadline calculator and an object manager calculate missing information based on historical records and corresponding rules and user settings. The plurality of user devices capable of managing, document object actions such as accept, deny, or pause document objects or actions, driven by pre-configured parameters and internal system rules related to single or ongoing deadlines and/or other triggers. A proximity manager to manage deadline triggers based on a plurality of rules based on date distances from computed deadlines.

### CROSS-REFERENCE TO RELATED APPLICATIONS

This application claims the benefit of priority under 35 U.S.C § 120 as a continuation of U.S. application Ser. No. 15/284,455, filed on Oct. 3, 2016 and entitled “System and Method for Systematic Presentation and Ordering of Documents Based on Triggers, which is (i) a continuation in part of U.S. application Ser. No. 14/104,430, filed on Dec. 12, 2013 and entitled “System and Method to Utilize Presumptions, Database Information, and/or User Defaults to Calculate Construction Lien, Notice, Bond Claim, and Other Construction Document Deadlines and Requirements”; (ii) a continuation in part of U.S. application Ser. No. 13/490,781, filed on Jun. 7, 2012 and entitled “Method for Purchasing or Generating Construction Liens and Notice Documents from Calculated Deadlines and Smart Recognition of Deadline Satisfaction via a Communication Network”; and (iii) claims the benefit of priority to U.S. provisional application No. 62/235,745, filed on Oct. 1, 2015 and entitled, “Automatic Queueing or Other Systematic Presentation and/or Ordering of Documents or Actions with the Ability to Accept, Deny, or Pause said Documents or Actions, Driven by User-Defined Parameters and Internal System Logic Related to Single or Ongoing Deadlines and/or Other Triggers,” the contents of each of which are incorporated herein by reference in their entirety.

### BACKGROUND OF THE INVENTION

### Field of the Art

The present invention relates to the field of security instruments in the construction field, specifically as related to mechanic's lien and bond claim compliance.

### Discussion of the State of the Art

Those furnishing labor, materials and/or services to private, state, and/or federal construction projects throughout the United States have possible “mechanic's lien” or bond claims in the event they are unpaid for their contribution to the improvement. Generally referred to as a “mechanic's lien,” the legal remedy is also called, among other things, a “claim of lien,” “materialmen's lien,” “property lien,” “contractor lien,” “construction lien,” “statement of claim and privilege,” “notice of claim of lien,” and “stop work order.” When the labor, materials, and/or services are furnished to a construction project owned privately (non-governmental ownership), the lien is placed against the property itself. When the labor, materials or services are furnished to a state or federal construction project, a lien against the government owned property is typically not available, but instead a “lien” is generally made against a bond, or, in some cases, against the funds remaining to be paid by the public entity, under the federal Miller Act or each individual state's “Little Miller Act.” This lien remedy, which goes by many names and has different characteristics depending on the construction project's type, is referred to herein collectively as a “mechanic's lien.”

While the ability to file a mechanic's lien is uniformly available across the United States and its territories, the laws regulating its filing differs from state-to-state. In addition to each state having unique mechanic's lien laws, within these laws different treatment is afforded to construction participants depending on their role in the project (i.e. original contractor, subcontractor, architect, supplier, equipment lessor, etc.), their tier in the project (i.e. their place in the contractual chain starting from the property owner or public entity commissioning work) and the type of construction project where services are furnished (i.e. commercial, residential, owner-occupied residential, industrial, oil & gas, state, federal, etc.).

To preserve one's right to file a mechanics lien, many states require project participants to meet pre-lien statutory notice requirements. In some states, notices are required before services are provided, and in others notices are required within a certain period before the lien is filed. In other states, notices are not required at all. These notices must meet statutory requirements, and must be sent according to the state's statutory service or delivery standards. These construction notices, including, but are not limited to, notices of the following names and types: preliminary notices, pre-lien notices, notices to owner, notices of commencement, notices of intent to lien, notices of furnishing labor/materials, notices of lease, model disclosures, notices of completion or cessation, notices of lease, etc. Similar to a mechanic's lien, each state has specific requirements for how and when notices must be filed, served, or sent, to whom notices must be filed, served, or sent, and what must be included on the notice. These notices differ from mechanic's liens in that notices are only preliminary documents necessary to retain the right to claim a mechanic's lien at a later date, or optionally sent to notify or warn a recipient about the right to claim a mechanic's lien at a later date. The notices, collectively herein referred to as “preliminary notices” or “construction notices,” where and when required, may be necessary to a claim a mechanic's lien, but are not sufficient, by themselves, for a mechanic's lien.

Each notice has specific and varied legal requirements, regarding who is to be given notice, how they must be given notice, and when the notice must be given. In some states, the notices are required to be given on a recurring basis for every month in which the potential lien claimants are unpaid for their work. The legal requirements for construction notices also vary by the role of the party giving notice (i.e. general contractor, subcontractor, material supplier, equipment lessor, etc.), as well as by the state in which the project was located, and the project type (i.e. commercial, residential, public, etc.). As well as these required notices, many states also 1) have notices that are not specifically required but may provide some benefit to the noticing party (“best practice notices”), and/or 2) allow for the delivery of purely voluntary notices to provide information the noticing party desires to be given.

The act of filing a mechanics lien is also subject to varied legal requirements, with each state setting forth specific elements required within a mechanic's lien. These requirements include, but are not limited to, deadlines by which the lien must be filed and served, specific service and filing requirements, and deadlines by which the lien must be enforced. Finally, the mechanic's lien is a temporary encumbrance on private property or a surety bond. The encumbrance lasts for a specific period of time as provided by each jurisdiction's statute, and the encumbrance expires at the end of this time period unless action is taken by the lien claimant. In some jurisdictions, the mechanic's lien claim may be “extended” through a supplemental filing. When unable to extend or further extend a lien, the mechanic's lien claim must be “foreclosed upon” by filing an action seeking foreclosure in a designated court of law.

Accordingly, mechanics lien and bond claim compliance is an important compliance item for construction industry participants, including general contractors, subcontractors, other trade contractors, architects, engineers, suppliers, and others. The compliance framework, as discussed above, is extraordinarily complex, governed by rules and requirements that differ depending on the location of a construction project, and characteristics of the construction project itself.

Determining the compliance requirements for a particular construction project typically requires data about that project that is not kept in the ordinary course of business by construction project participants, either manually or within any other project management or accounting software used by said participant.

As examples of this, consider that mechanics lien and bond claim compliance require knowledge about whether a project is commercial, new residential, owner-occupied residential, state, or federal in character, from a statutory standpoint. Many project management systems for contraction participants, as well as the participants themselves, do not track these distinctions in line with statutory definitions, or provide useful or actionable next actions in order for the participant to remain secure.

Despite, and as well as, the requirements for notices and/or other documents set forth by the laws of the project state, many construction participants have their own rules and requirements, generally (but not always) set forth by the credit department, related to the providing of notices and/or other construction documents and/or security devices. For example, some parties may only wish to send notices, whether required or not, on projects for which they have provided a certain value of labor and/or materials; or, some parties may completely exclude certain customers from receiving notices or other construction documents. Further, parties may desire to only send certain notices or other documents if payment is late, or for other reasons.

Additionally, parties at or towards the top of the construction contracting chain, Property Owners, General Contractors, Sureties, Lenders, etc. (“top tier parties”), also have voluntary or required filings, timing requirements, and opportunities related to mechanic's liens and managing lien exposure on a project. These documents or actions can be notices or filings similar in practice to the notices and filings lower-tiered parties use to retain lien rights. Some of these types of documents include, but are not limited to, Notices of Commencement, Notices of Completion, Notices of Non-Responsibility, or notices to request certain information from other parties. Some of these documents or actions relate to the top tier parties' ability to respond to notice or lien filings. And, some of these documents or actions relate to the ability of the top tier parties to track project participants.

What is needed is a system and method that provides a systematic ordering of available next actions for all parties on a construction project, with such queue of next actions determined by both the specific requirements of each project, and user-defined parameters. The items appearing in the queue of next actions as determined by the confluence of the specific requirements and user-defined restrictions can be accepted/ordered, denied, or paused for a set period of time, each action removing the action item from the queue either permanently or for a set period of time.

### SUMMARY OF THE INVENTION

Accordingly, the inventor has conceived and reduced to practice, in a preferred embodiment of the invention, a systematic presentation of documents or actions with the ability to accept, deny, or pause documents or actions, driven by user-defined parameters and internal system logic related to single or ongoing deadlines and/or other triggers.

According to a preferred embodiment of the invention, a systematic ordering of available next actions for parties on a construction project, with such queue of next actions determined by both the specific requirements of each project, and user-defined parameters is disclosed. The items appearing in the queue of next actions as determined by the confluence of the specific requirements and user-defined restrictions can be accepted/ordered, denied, or paused for a set period of time, each action removing the action item from the queue either permanently or for a set period of time.

A preferred embodiment of the invention allows the user to manage the confusing and convoluted requirements related to construction security instruments or other construction documents, coupled with the user's internal requirements or desires regarding same. The invention allows the user to set their own requirements and/or limitations regarding construction or related documents, combines those requirements and/or limitations with the specific rules and requirements set forth by law to the specific project (and based on user selected status, status indications automatically generated based on user data, status indications automatically generated based on aggregated data, rules based on user data, and/or rules based on aggregated data), and display in an ordered next-action list solely the actions meeting both criteria, from which the user may choose to accept/order the document/action, deny the document/action, or pause the decision on the document/action to a later time.

A preferred embodiment of the invention is applicable to businesses (i) who are construction project participants and need to comply with lien and bond claim requirements (i.e. subcontractors, suppliers, etc.); (ii) who are construction project participants that need to manage lien exposure or otherwise manage proactive or responsive actions regarding documents other than lien documents; (iii) are in the business of preparing and sending or filing construction documents, including liens, bond claims, or notices, on behalf of other businesses (i.e. construction lien and notice companies); (iv) who publish or use software and/or other tools, applications, or platforms to assist in the preparation and sending of construction notices, liens, bond claims, and other construction documents (i.e. construction project management systems, notice and lien management system, document assembly tools, accounting applications, etc.); and (v) who publish or use software that calculates or determines, using any method, the lien or bond claim deadlines applicable to a user or a user's project.

A preferred embodiment of the invention is an improvement over systems known in the art because it provides an ability to streamline and automate or manually manage the determination of critical compliance dates coupled with internal requirements to provide a list of applicable next actions.

### BRIEF DESCRIPTION OF THE DRAWING FIGURES

The accompanying drawings illustrate several embodiments of the invention and, together with the description, serve to explain the principles of the invention according to the embodiments. It will be appreciated by one skilled in the art that the particular embodiments illustrated in the drawings are merely exemplary, and are not to be considered as limiting of the scope of the invention or the claims herein in any way.

FIG. 1 is a block diagram illustrating an exemplary hardware architecture of a computing device used in an embodiment of the invention.

FIG. 2 is a block diagram illustrating an exemplary logical architecture for a client device, according to an embodiment of the invention.

FIG. 3 is a block diagram showing an exemplary architectural arrangement of clients, servers, and external services, according to an embodiment of the invention.

FIG. 4 is another block diagram illustrating an exemplary hardware architecture of a computing device used in various embodiments of the invention.

FIG. 5 is a block diagram illustrating an exemplary architecture of next-action queue system, according to a preferred embodiment of the invention.

FIG. 6 is a block diagram illustrating a plurality of objects used in a next-action queue system, according to a preferred embodiment of the invention.

FIG. 7 is a flow diagram illustrating an exemplary method whereby upon certain information being missing from a project record, it is supplemented with user default data, or if not available, presumptive data, to calculating a deadline or requirement.

FIG. 8 is a graphical representations that specifically reviews how the user role function can be presumed with a hiring role induction, serving as an example of how such an administrative “if” and “then” rule could be established with regards to the relationship between these two roles.

FIG. 9 is a graphical representation of the process employed by this invention if a project type data element is missing.

FIG. 10 is a graphical representation of the process employed by this invention if a user role data element is missing.

FIG. 11 is a graphical representation of the process employed by this invention if a date data element is missing.

FIG. 12 is an illustration of exemplary workflow settings for a user device, according to a preferred embodiment of the invention.

FIG. 13 is an exemplary illustration of a plurality of filters customizable by a user device, according to a preferred embodiment of the invention.

FIG. 14 is an exemplary illustration of user selectable jurisdictions, according to a preferred embodiment of the invention.

FIG. 15 is an exemplary illustration of user selectable project types, according to a preferred embodiment of the invention.

FIG. 16 is an exemplary illustration of user device control of queued documents, according to a preferred embodiment of the invention.

FIG. 17 is an exemplary illustration of a populated next-action queue, according to a preferred embodiment of the invention.

FIG. 18 is an exemplary illustration of a queue process, according to a preferred embodiment of the invention.

### DETAILED DESCRIPTION

The inventor has conceived, and reduced to practice, a system and method that provides an actionable next-action queue based on a combination of user preferences and parameters. Specific construction documents appear as a next action in a queue when one or more documents meet a plurality of project-specific requirements, including, but not limited to, legal requirements and user-defined parameters. The user is enabled to take certain actions regarding documents appearing as next-action items in the queue, including approving/ordering the document/action, denying/cancelling the document/action, or pausing the order/action for a set time period at the end of which the document will re-populate in the queue for consideration.

One or more different inventions may be described in the present application. Further, for one or more of the inventions described herein, numerous alternative embodiments may be described; it should be appreciated that these are presented for illustrative purposes only and are not limiting of the inventions contained herein or the claims presented herein in any way. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural, logical, software, electrical and other changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

### Definitions

The construction industry is one of the largest industries in the United States, and includes a variety of parties who engage in the construction or alteration of any improvement projects. Throughout this application, a project as a whole will be referred to as a “project” or “construction project.”

Improvement projects may be of a variety of “types,” which include residential projects, commercial projects, industrial projects, state owned projects or works, federally owned project works, and more. Throughout this application, this will be referred to as a “project type.”

A variety of parties participate in the construction or alteration of said improvement projects. Parties are identified by the roles they play on an improvement project, and may be classified as a developer or owner, a general contractor, construction manager, architect, engineer, subcontractor, trade contractor, supplier, sub-subcontractor, sub-sub-subcontractor, sub-sub-sub-subcontractor, equipment rental company or equipment lessor, lender, mortgagor, lien agent, or more. Throughout this application, this will be referred to as a “role.”

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

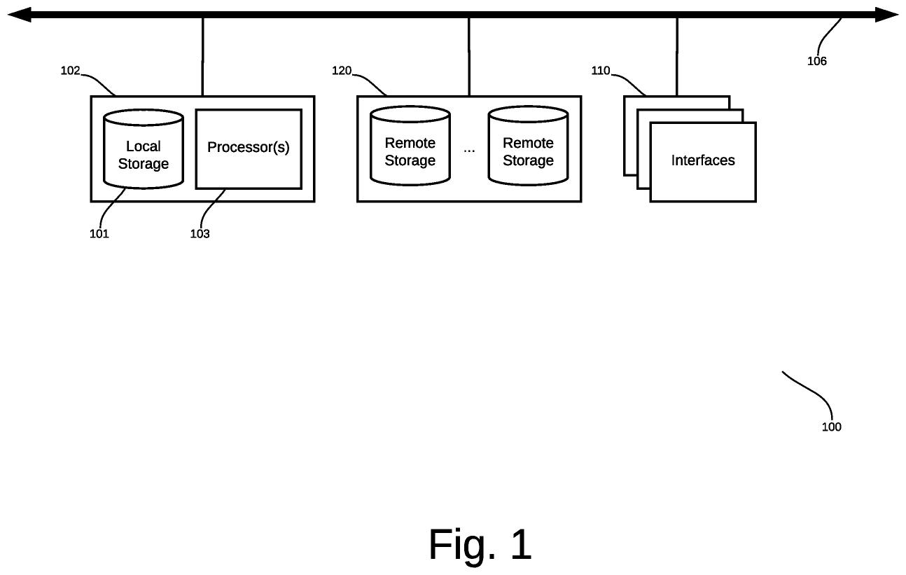

Referring now to FIG. 1, there is shown a block diagram depicting an exemplary computing device 100 suitable for implementing at least a portion of the features or functionalities disclosed herein. Computing device 100 may be, for example, any one of the computing machines listed in the previous paragraph, or indeed any other electronic device capable of executing software- or hardware-based instructions according to one or more programs stored in memory. Computing device 100 may be adapted to communicate with a plurality of other computing devices, such as clients or servers, over communications networks such as a wide area network a metropolitan area network, a local area network, a wireless network, the Internet, or any other network, using known protocols for such communication, whether wireless or wired.

In one embodiment, computing device 100 includes one or more central processing units (CPU) 102, one or more interfaces 110, and one or more busses 106 (such as a peripheral component interconnect (PCI) bus). When acting under the control of appropriate software or firmware, CPU 102 may be responsible for implementing specific functions associated with the functions of a specifically configured computing device or machine. For example, in at least one embodiment, a computing device 100 may be configured or designed to function as a server system utilizing CPU 102, local memory 101 and/or remote memory 120, and interface(s) 110. In at least one embodiment, CPU 102 may be caused to perform one or more of the different types of functions and/or operations under the control of software modules or components, which for example, may include an operating system and any appropriate applications software, drivers, and the like.

CPU 102 may include one or more processors 103 such as, for example, a processor from one of the Intel, ARM, Qualcomm, and AMD families of microprocessors. In some embodiments, processors 103 may include specially designed hardware such as application-specific integrated circuits (ASICs), electrically erasable programmable read-only memories (EEPROMs), field-programmable gate arrays (FPGAs), and so forth, for controlling operations of computing device 100. In a specific embodiment, a local memory 101 (such as non-volatile random access memory (RAM) and/or read-only memory (ROM), including for example one or more levels of cached memory) may also form part of CPU 102. However, there are many different ways in which memory may be coupled to system 100. Memory 101 may be used for a variety of purposes such as, for example, caching and/or storing data, programming instructions, and the like. It should be further appreciated that CPU 102 may be one of a variety of system-on-a-chip (SOC) type hardware that may include additional hardware such as memory or graphics processing chips, such as a Qualcomm SNAPDRAGON™ or Samsung EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interfaces 110 are provided as network interface cards (NICs). Generally, NICs control the sending and receiving of data packets over a computer network; other types of interfaces 110 may for example support other peripherals used with computing device 100. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 110 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 1 illustrates one specific architecture for a computing device 100 for implementing one or more of the inventions described herein, it is by no means the only device architecture on which at least a portion of the features and techniques described herein may be implemented. For example, architectures having one or any number of processors 103 may be used, and such processors 103 may be present in a single device or distributed among any number of devices. In one embodiment, a single processor 103 handles communications as well as routing computations, while in other embodiments a separate dedicated communications processor may be provided. In various embodiments, different types of features or functionalities may be implemented in a system according to the invention that includes a client device (such as a tablet device or smartphone running client software) and server systems (such as a server system described in more detail below).

Regardless of network device configuration, the system of the present invention may employ one or more memories or memory modules (such as, for example, remote memory block 120 and local memory 101) configured to store data, program instructions for the general-purpose network operations, or other information relating to the functionality of the embodiments described herein (or any combinations of the above). Program instructions may control execution of or comprise an operating system and/or one or more applications, for example. Memory 120 or memories 101, 120 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a Java™ compiler and may be executed using a Java virtual machine or equivalent, or files containing higher level code that may be executed by the computer using an interpreter (for example, scripts written in Python, Perl, Ruby, Groovy, or any other scripting language).

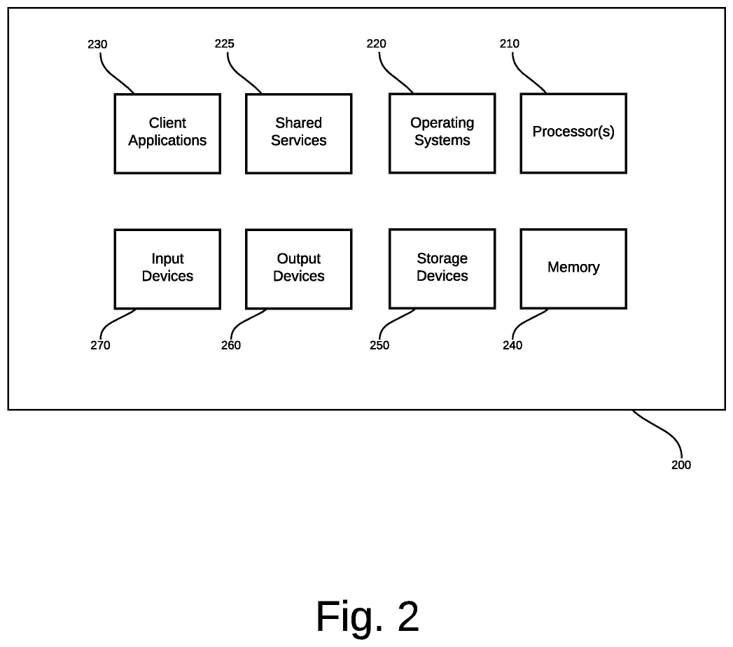

In some embodiments, systems according to the present invention may be implemented on a standalone computing system. Referring now to FIG. 2, there is shown a block diagram depicting a typical exemplary architecture of one or more embodiments or components thereof on a standalone computing system. Computing device 200 includes processors 210 that may run software that carry out one or more functions or applications of embodiments of the invention, such as for example a client application 230. Processors 210 may carry out computing instructions under control of an operating system 220 such as, for example, a version of Microsoft's WINDOWS™ operating system, Apple's Mac OS/X or iOS operating systems, some variety of the Linux operating system, Google's ANDROID™ operating system, or the like. In many cases, one or more shared services 225 may be operable in system 200, and may be useful for providing common services to client applications 230. Services 225 may for example be WINDOWS™ services, user-space common services in a Linux environment, or any other type of common service architecture used with operating system 210. Input devices 270 may be of any type suitable for receiving user input, including for example a keyboard, touchscreen, microphone (for example, for voice input), mouse, touchpad, trackball, or any combination thereof. Output devices 260 may be of any type suitable for providing output to one or more users, whether remote or local to system 200, and may include for example one or more screens for visual output, speakers, printers, or any combination thereof. Memory 240 may be random-access memory having any structure and architecture known in the art, for use by processors 210, for example to run software. Storage devices 250 may be any magnetic, optical, mechanical, memristor, or electrical storage device for storage of data in digital form (such as those described above, referring to FIG. 1). Examples of storage devices 250 include flash memory, magnetic hard drive, CD-ROM, and/or the like.

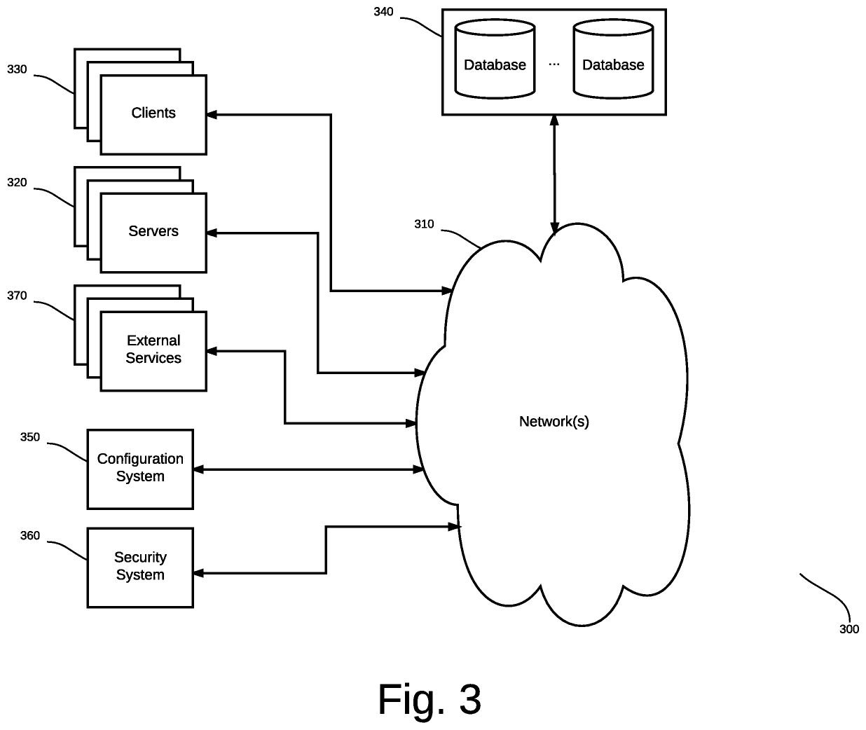

In some embodiments, systems of the present invention may be implemented on a distributed computing network, such as one having any number of clients and/or servers. Referring now to FIG. 3, there is shown a block diagram depicting an exemplary architecture 300 for implementing at least a portion of a system according to an embodiment of the invention on a distributed computing network. According to the embodiment, any number of clients 330 may be provided. Each client 330 may run software for implementing client-side portions of the present invention; clients may comprise a system 200 such as that illustrated in FIG. 2. In addition, any number of servers 320 may be provided for handling requests received from one or more clients 330. Clients 330 and servers 320 may communicate with one another via one or more electronic networks 310, which may be in various embodiments any of the Internet, a wide area network, a mobile telephony network (such as CDMA or GSM cellular networks), a wireless network (such as WiFi, Wimax, LTE, and so forth), or a local area network (or indeed any network topology known in the art; the invention does not prefer any one network topology over any other). Networks 310 may be implemented using any known network protocols, including for example wired and/or wireless protocols.

In addition, in some embodiments, servers 320 may call external services 370 when needed to obtain additional information, or to refer to additional data concerning a particular call. Communications with external services 370 may take place, for example, via one or more networks 310. In various embodiments, external services 370 may comprise web-enabled services or functionality related to or installed on the hardware device itself. For example, in an embodiment where client applications 230 are implemented on a smartphone or other electronic device, client applications 230 may obtain information stored in a server system 320 in the cloud or on an external service 370 deployed on one or more of a particular enterprise's or user's premises.

In some embodiments of the invention, clients 330 or servers 320 (or both) may make use of one or more specialized services or appliances that may be deployed locally or remotely across one or more networks 310. For example, one or more databases 340 may be used or referred to by one or more embodiments of the invention. It should be understood by one having ordinary skill in the art that databases 340 may be arranged in a wide variety of architectures and using a wide variety of data access and manipulation means. For example, in various embodiments one or more databases 340 may comprise a relational database system using a structured query language (SQL), while others may comprise an alternative data storage technology such as those referred to in the art as “NoSQL” (for example, Hadoop Cassandra, Google BigTable, and so forth). In some embodiments, variant database architectures such as column-oriented databases, in-memory databases, clustered databases, distributed databases, or even flat file data repositories may be used according to the invention. It will be appreciated by one having ordinary skill in the art that any combination of known or future database technologies may be used as appropriate, unless a specific database technology or a specific arrangement of components is specified for a particular embodiment herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, most embodiments of the invention may make use of one or more security systems 360 and configuration systems 350. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments of the invention without limitation, unless a specific security 360 or configuration system 350 or approach is specifically required by the description of any specific embodiment.

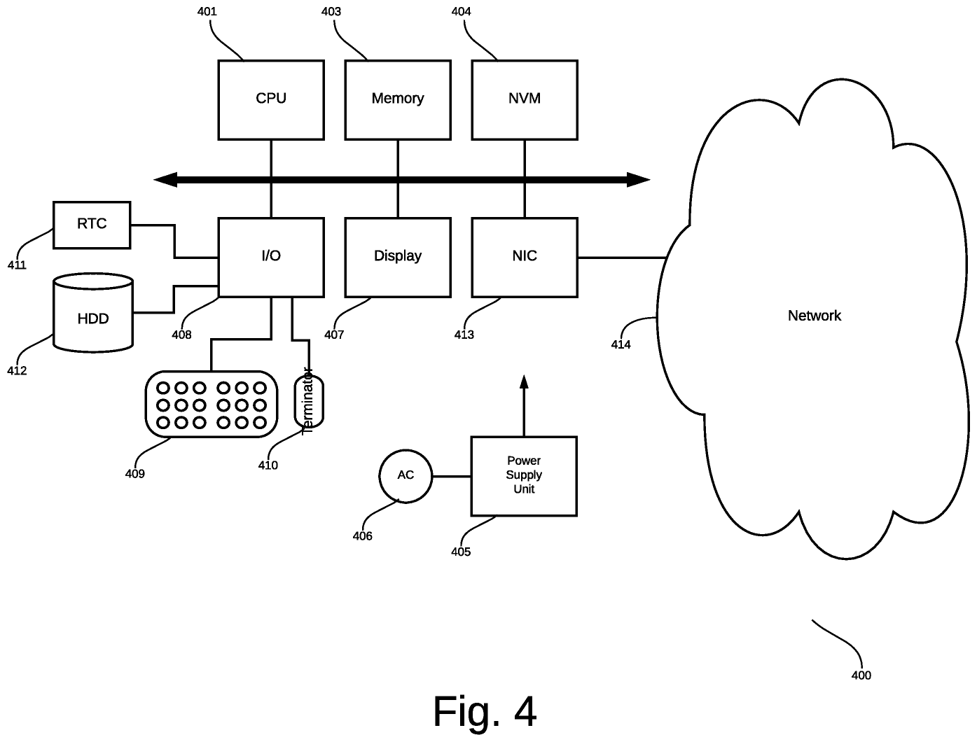

FIG. 4 shows an exemplary overview of a computer system 400 as may be used in any of the various locations throughout the system. It is exemplary of any computer that may execute code to process data. Various modifications and changes may be made to computer system 400 without departing from the broader spirit and scope of the system and method disclosed herein. CPU 401 is connected to bus 402, to which bus is also connected memory 403, nonvolatile memory 404, display 407, I/O unit 408, and network interface card (NIC) 413. I/O unit 408 may, typically, be connected to keyboard 409, pointing device 410, hard disk 412, and real-time clock 411. NIC 413 connects to network 414, which may be the Internet or a local network, which local network may or may not have connections to the Internet. Also shown as part of system 400 is power supply unit 405 connected, in this example, to ac supply 406. Not shown are batteries that could be present, and many other devices and modifications that are well known but are not applicable to the specific novel functions of the current system and method disclosed herein. It should be appreciated that some or all components illustrated may be combined, such as in various integrated applications (for example, Qualcomm or Samsung SOC-based devices), or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of the present invention may be distributed among any number of client and/or server components. For example, various software modules may be implemented for performing various functions in connection with the present invention, and such modules may be variously implemented to run on server and/or client components.

### Conceptual Architecture

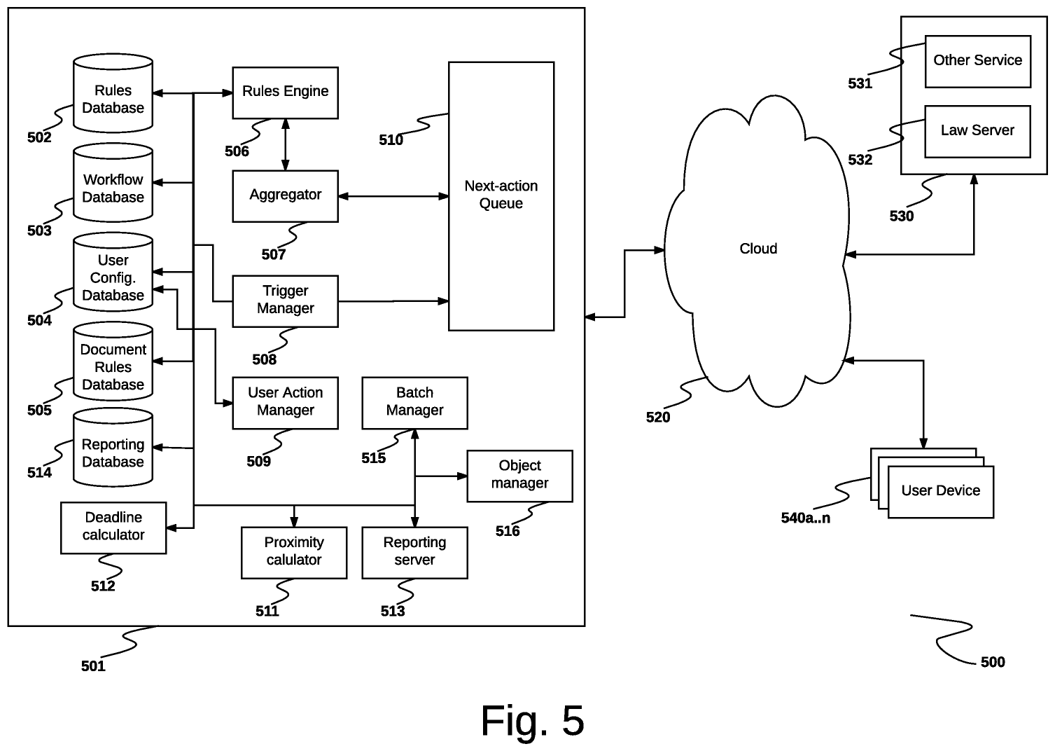

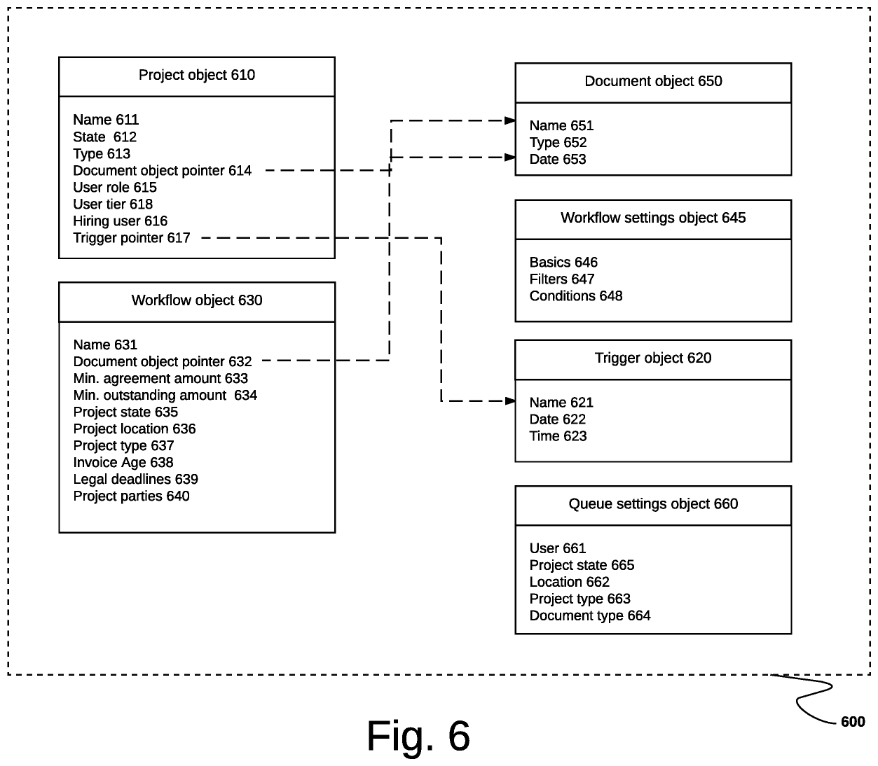

FIG. 5 is a block diagram illustrating an exemplary architecture of next-action queue system 500, according to a preferred embodiment of the invention. According to the embodiment, an actionable and manageable next-action queue system based on legal and/or user-defined parameters, and providing an action to be taken regarding the documents/actions appearing in next-action queue 510, is disclosed. The population of next-action queue 510 is determined by the connecting and associating at least a portion of the following elements: (i) The specific rules and requirements (defined by rules engine 506 and stored in rules database 502) may be determined by law (for example, as received from one or more external services 530, for example law server 532) to a specific project object 610 (as in FIG. 6). It should be appreciated that law server 532 may be computer server comprising a processor and a memory and further comprising programmable code stored in the memory and executing on the processor, the programmable instructions configured to act as a repository for, at least, laws associated to legal documents (for example, a mechanic's lien). Law server 532 may define, at least, a plurality of laws regulating filing for different document types that may differ from region to region (for example, in the United States, federally and from state-to-state). In addition to each region having unique mechanic's lien laws, within these laws there may be different treatment afforded to construction participants depending on their role in the project as defined in user role 615 of project object 610 (for example, original contractor, subcontractor, architect, supplier, equipment lessor, etc.), their tier in the project defined in user tier 618 (for example, their place in the contractual chain starting from the property owner or public entity commissioning work) and the type of construction project where services are furnished, as defined in type 613 of project object 610 (for example, commercial, residential, owner-occupied residential, industrial, oil & gas, state, federal, etc.). In some embodiments, law server 532 may be a terminal used by one with skill in the art of law for a plurality of documents types. Rules, managed by rules engine 506 and stored in rules database 502, associated to next-action queue 510 may be based on selected status, status indications automatically generated based on user data, status indications automatically generated based on aggregated data (from aggregator 507) from an associated user device 540a . . . n, rules based on user data from user configuration database 504, and/or rules based on aggregated data as aggregated by aggregator 507; (ii) The characteristics, rules and requirements of a specific document object 650 appearing in next-action queue 510; and (iii) The user's specific work-flow preferences define in an associated workflow settings object 645 stored in user configuration database 504 and parameters defined in user configuration database 504 related to a specific document type 652 of the associated document object 650.

Population of next-action queue 510 by project and document specific requirements as defined by project object 610 may be managed by rule engine 506 and rules may be set forth by, at least, laws for a particular region (for example, as received from law server 532) and/or user-defined parameters (for example, defined in user configuration database 504) and requirements related to specific document type 652 of an associated document object 650 associated to project object 610, or any combination thereof.

In a preferred embodiment, a calculation of document specific deadline requirements may be computed using document characteristics and cross referencing with information received from law server 532 by deadline calculator 512, and may execute as follows. In order to populate next-action queue 510 with actionable items based on a combination of requirements set forth by law (as received by law server 532) and parameters set forth by first user device 540a and stored in user configuration database 504, or solely by the requirements set forth by law, an applicable deadline set forth by, at least, law, may be calculated by deadline calculator 512. In this regard, the relationships between several pieces of discrete project data, including: the project's state 612; the project's type 613; the user's role in the project 615; the role in the project of the party who hired the user 616; and, applicable trigger dates/times defined in one or more associated trigger objects 620 (as referenced by trigger pointer 617) are examined and compared by rules engine 506. Rules engine 506 compares the information with document object manager 516, rules engine 506, and deadline calculator 512 to determine deadlines associated to the provided datasets. All potentially applicable deadlines may accrue only after a certain preconfigured time period counting from a specific “trigger date” as defined in an associated trigger object 620 and triggered by trigger manager 508, such that the input of a particular trigger date 622 may prompt a related deadline. In some embodiments triggers are triggered after a certain time has passed as managed by proximity calculator 511 (that is, proximity or reference to a specific deadline or action date).

Upon inputting the date data into date 622 of trigger object 620, deadline calculator 512 may then apply a databased and chosen deadline calculation logic to date 622, counting, by the proximity calculator 511, the required time period from date 622. In counting days, months or years from the trigger date, proximity calculator 511 may contemplate whether the deadline should end before or after weekends and holidays, and contemplates which days are holidays for that project's jurisdiction by comparing a holiday schedule received from other service 531. In this regard, other service 531 may be a holiday server whereby a list of holidays per jurisdiction (for example, federally, by state, by religion, etc.) are received and inputted into rules database 502.

According to an embodiment of the invention, user-defined workflow parameters and general queue filters are disclosed. According to the embodiment, deadline calculator 512 can use either 1) the legally-defined deadlines calculated by deadline calculator 512 and next actions stored within document rules database 505, 2) user-defined workflow parameters defined in workflow object 630 related to a specific document-type stored in workflow database 503, or 3) a combination thereof, in order to determine which next-action/document, associated to a particular workflow object 630, should appear in next-action queue 510. Specifically, the embodiment takes the possible next actions based on the project information as defined in project object 610 and deadlines calculated by deadline calculator 512 (if applicable), and runs it through filter 647 defined by a plurality of user-input parameters received from an associated first user device 540a in order to display one or more next-action/documents that meet a specified criteria corresponding to filter 647. In some embodiments aggregator 507 decides on data within the associated project object based on preferences in, at least, an associated profile in user configuration database 504 and rules database 502. Actions to affect one or more documents in next-action queue 510 may be received from first user device 540a that may accept/order the next-action document, deny/cancel the next-action/document, pause the next-action/document for a specified period of time, and the like. This allows first user device 540a to view and manage the next-action/documents by approving, denying, or pausing only documents that meet specific specifications received from first user device 540a. In some embodiments, commands received from first user device 540a are stored into user configuration database 504 and the above process relies on preconfigured preferences and actions.

Filters used to populate records (defined by document object 650) within next-action queue 510 associated to first user device 540a are separated by next-action document, i.e. separate and specific queue workflow parameters (each defined by workflow object 630) are associated to a user device of the plurality of user devices 540a . . . n by next-action/document (for example, a preliminary notice workflow is separate from a lien workflow), as well as other preferences set in user configuration database 504. In this regard, factors may be segregated, such as, by a particular line of business associated to a user of first user device 540a. That is, records (defined by document object 650) associated to first user device 540a may have differing queue workflow parameters, for example, for repair work and new construction. Other workflow parameters defined in workflow object 630 (associated to first user device 540a) may be specifically defined in categories in order to drive next-action/documents into next-action queue 510 to include an amount due, a proximity (as calculated by proximity calculator 511) to a legally-defined deadline, an age of any associated invoices, or the parties.

Referring now to FIG. 6. FIG. 6 is a block diagram illustrating a plurality of objects used in a next-action queue system, according to a preferred embodiment of the invention. According to the embodiment, workflow settings, by which different sets of documents can be driven to a next-action/document state within next-action queue 510 are defined by workflow object 630 which comprises, at least: name 631 comprising a name for an associated workflow; document object pointer 632 comprising one or more pointer to associated documents; minimum agreement amount 633 comprising a minimum agreement amount for the associated project; minimum outstanding amount 634 which comprises a minimum outstanding amount for the project; project state 635 which comprises a state for the project; project location 636 which comprises a location associated to the project; project type 637 which defined a type of project associated to the project; invoice Age 638 which comprises an age for an associated invoice for the project; legal deadlines 639 which comprises deadlines as received from law server 532; project parties 640 which comprises one or more parties associated to the associated project. In some embodiments, other information may be included to workflow object 630 to further define the associated workflow.

Queue settings object 660 associated to first user device 540a via user 661 may be configured to specify to which projects and or documents the workflow applies, and to have that specific workflow apply solely to the desired projects/documents, such that different queue workflow settings may be chosen for each project state 665, location 662 project type 663, document type 664, if so desired, to allow for the customization for driving potential next-action/documents into the queue, whereupon those next-actions/documents may be accepted/ordered, denied/cancelled, or paused driven in real-time by first user device 540a or from stored configurations in user configuration database 504 associated to first user device 540a. In some embodiments, more fields to further control records in next-action queue 510 associated to first user device 540a may be configured.

In some embodiments, first user device 540a may configure one or more filters (in an associated workflow settings object 645) to allow a selection that may determine when an item will appear in the next-actions/document queue 510, how long the next-action/document will remain in the queue for manual action (“turnover period”) and how the next-action/document will be processed upon the expiration of its time in the queue during which a manual action could have been taken.

It can be appreciated that in a preferred embodiment of the invention this capability allows a configuration of a next-action queue 510 that displays documents associated based on filters such as, by user, by location, or any other configurable fields in object 600. In a preferred embodiment, workflow settings object 645 may comprise, at least, basic configuration 646, filter configuration 647, and condition configuration 648.

In some embodiments, as a precursor to setting workflow parameters to drive next-action/documents into the queue, a document type is received from first user device 540a to be governed by applicable workflow settings defined in workflow settings object 645. Document types may include, but not limited to preliminary notices, monthly preliminary notices (applicable to certain specific regions with recurring deadlines), notices of intent to lien, and liens. Once one a type has been received from first user device 540a, a customization of an associated workflow such that the user is given complete control of the next-actions/documents are received from first user device 540a. Associated documents may then be shown, based on preferences set, to first user device 540a on an associated interface running on first user device 540a.

A basic configuration (as defined in basics 646 of workflow settings object 645) allows an associated first user device 540a to assign a name to a preference set, determine how an item in next-action queue 510 (associated to first user device 540a) is processed: for example, automatically, automatically unless manually removed by first user device 540a, or only if manually approved by first user device 540a, selection of a turnover period upon the expiration of which an item may be removed from next-action queue 510.

Filters, as defined by filters 647 of workflow settings object 645, allow for the customization of a behavior of documents within next-action queue 510 associated to first user device 540a by setting project state, project location, project type, line of business, and the like to which filters apply. For example, a large nationwide user, via first user device 540a, may have different credit practices by region, this workflow setting may allow that user to specify different workflows for preliminary notices for work contracted by different company location even if all the other aspects of the project are otherwise the same. Likewise, first user device 540a may opt for different preferences for different states, different locations, different project types, etc. According to the filters chosen, the preferences may only be applied to the items that fit the criteria of the filters. Additionally, user devices 540a . . . n have the ability to set up specific workflow rules based on the parties who are present on the project. This means that the user may elect to exclude certain parties (for example, large customers or other parties with whom the user has a delicate relationship); or create specific “groups” of parties to be treated in different manners and assigned different or special rules. For example, a user may have a specific number of customers that are deemed more “risky” such that stricter rules may be used to determine when next-actions/documents related to those parties appear in next-action queue 510.

Conditions, as defined in conditions 648 of workflow settings object 645, section request an associated first user device 540a to set conditions for the above preferences. Conditions 648 determine when a next-action/document will be placed into next-action queue 510. Conditions 648 allow first user device 540a to customize documents within next-action queue 510 by defining, using proximity calculator 511, how close to an existing system-calculated legal deadline is, or how overdue a payment must be before triggering, by trigger manager 508, an applicable next-action/document to be placed in next-action queue 510; and, it allows first user device 540a to set a threshold for the minimum amount (whether past due or the total agreement) that must be met before a next-action/document is placed in next-action queue 510. Other conditions within conditions 648 may include setting a date from which the workflow settings will be utilized, and determining whether or not next-action/documents with expired deadlines, and/or voluntary documents will be populated into next-action queue 510.

Further, a preferred embodiment of the invention, conditions 648 are configured to populating next-actions/documents into next-action queue 510 based on analyses of the historical performance of the specific next-action/documents related to the specific conditions (i.e. state, project-type, location, amount, etc.) to which it may apply. This capability may enable smart management of the potential next-actions/documents being driven into next-action queue 510 by applying machine-learning or algorithmic conclusions related to the performance of a particular document in a particular situation and adjusting the conditions accordingly to provide an improved mechanism for managing projects over systems known in the art.

It should be appreciated that objects 600 may be related to each other through database records (for example name field) and identifiers in any combination.

referring again to FIG. 5, in a preferred embodiment of the invention, reporting server 513 may manage reporting information for system 501, including but not limited to, interactions described by objects 600, historical behavior of configurations to outcome of project (as defined by, for example, changes in project state) whereby reporting information is stored in reporting database 514. Specifically, for first user device 540a, reporting server 503 may track accounts receivable (hereinafter, referred to as “A/R”) performance associated to first user device 540a which, in this regard, may be separated by queue preferences; for example, reporting server 513 may compute, for example, that A/R performed significantly better (or worse) based on how, at least, conditions 648 were modulated, and provide insight to maximize performance of A/R based on calculations associated to specific conditions 648. By running reports on A/R performance separated by different queue workflow settings as defined in workflow setting object 645, workflow settings may be optimized, either by first user device 540a or automatically by rules engine 502 producing a configuration that may be used on other next-actions/documents within next-action queue 510 to provide an optimal set of conditions 648 (and other settings) to achieve the best A/R success. In some embodiments, workflow settings within workflow setting objects may be shared amongst a plurality of user devices 540a . . . n or automatically suggested by rules engine 506.

According to an embodiment, special situations related to “monthly” notice queue may exist whereby certain jurisdictions have construction notice deadlines that, rather than occurring one time and being met, may occur several times based on months in which work was performed on an associated project, or some other factor. For these jurisdictions, there are additional queue functions.

Accordingly, driving monthly notice action items based on A/R and/or workflows (either legal requirements, user-set parameters, or a combination thereof). As such, this function performs in a substantially similar manner as discussed in driving next-actions/documents to next-action queue 510 as discussed previously. According to the embodiment, first user device 540a sets specific workflow preferences through workflow object 630 that configures guidelines to drive notices into next-action queue 510. Specifically, for these monthly notice actions, however, the monthly next-actions/documents to which the conditions are applied can be determined by an analysis of an A/R performance associated to first user device 540a. Many of the monthly next-actions/documents are based upon, for example, months in which work was performed, but may have not been paid. By analysis of the sent, but outstanding, invoices by rules engine 506, a plurality of monthly next-actions/documents upon which the conditions should be layered to populate next-action queue 510 can be computed. For example, if the A/R analysis determined that there was an unpaid invoice for a particular month, that would create a next-action/document to which the conditions would be applied to determine if a document is driven to next-action queue 510. If the deadline is too far away to meet the user conditions, and/or if the outstanding invoice doesn't meet the threshold for driving a next-action/document to next-action queue 510, next-action queue 510 may not be populated, despite of the availability of an associated document object 650 based on the system's A/R analysis.

According to an embodiment, approval closing period based on timing and settings, is disclosed. According to the embodiment, an approval period for monthly next-actions/documents may begin, for example, on the day after the previous months' notice deadline. For example, in the state of Texas in the United States, since a deadline may always occur on the 15^{th} of a month, the approval period may begin on the 16^{th} of the month. In this regard, specific next-actions/documents may be populated into next-action queue 510 on, for example, the first day of the approval period based on preferences and workflow settings associated to first user device 540a as defined above. Once a notice order appears in next-action queue 510, an action may be received from first user device 540a regarding the next-actions/document, for example, approval/ordering, denial/cancellation during the approval period, and the like.

For example, in the case where an approval period ends at 3:00 PM on the third business day prior to the notice deadline. Once the approval period has concluded, only those orders that have been approved, either manually or automatically, may be processed. No new submissions or orders will be considered after the approval period has ended.

In some embodiments, where one or more user devices 540a . . . n are configured with “only if manually approved” workflow settings in an associated workflow settings object 645, all notice orders not approved by the end of the approval period may be automatically cancelled and may not be processed. In some embodiments, where one or more user devices 540a . . . n are configured with “automatically unless manually cancelled” workflow settings in an associated workflow settings object 645, all notice orders that have not been manually canceled may be automatically approved and processed. In this regard, the automatic workflow setting may result in an automatic approval and processing of all notice orders that match an associated configuration (for example, options set in an associated workflow setting object 645) of an associated user device of the plurality of user devices 540a . . . n.

According to some embodiments, setting delivery batches electronically for monthly notice grouping, is disclosed. According to the embodiment, monthly next-actions/documents deadlines may occur, for example, on a specific day after a particular month. In this regard, these monthly next-action/documents can be grouped into batches by batch manager 515 for batch delivery, as each of the monthly next-action/documents for a particular month may has the same, or similar, deadline. This means that all monthly notice documents (each corresponding to a document object 650) associated with the same month (whenever the document was ordered from next-action queue 510 or completed) can be held in a delivery batch, by batch manager 515, until immediately prior to the sending deadline such that all deliverable pieces can be sent at the same time. The embodiment, as related to the monthly notice queue, has an ability to set delivery batches electronically such that the monthly notices are held in this way, and delivered in a batch immediately prior to a delivery deadline. All next-actions/documents classified as monthly notice documents are identified by batch manager 515, held in a batch, and released for delivery immediately prior to the deadline. This discloses several improvements over systems known in the art, specifically, a first improvement is an ability to combine deliverable pieces to the same recipient, for example first user device 540a. If a recipient is to receive multiple different deliverable pieces, and all of these pieces are contained within the same delivery batch, deliverables can be combined into one, by batch manager 515, to, save postage costs and promote efficiency. Further, many parties who may wish to avoid sending monthly next-actions/documents for business reasons, and the holding of the delivery pieces in a batch by batch manager 515 until they must be sent, allows parties to pull deliverable pieces, as discussed in more detail below.

According to an embodiment of the invention, pulling one or more delivery pieces from pending delivery batch, by batch manager 515, in pull-period 1 is disclosed. As noted above, many parties may wish to avoid sending monthly next-actions/documents, for example, for business reasons. According to the embodiment, monthly notice next-actions/documents, holds associated documents in an electronically set batch by batch manager 515 until delivery prior to the deadline, rather than sending monthly next-actions/documents immediately upon approval, these completed monthly next-actions/documents can be “pulled” from the batch, for example, for a fee, and not sent if the user decides against sending a particular document, for whatever reason. Delivery pieces (for example, mail) can always be pulled from the batch in pull period 1. Pull period 1 is defined as the period of time from the close of the approval period (for example, “3:00 PM central time on the 3rd business day prior to the notice deadline”) until 3:00 AM central time on the day of the notice deadline.

According to an embodiment of the invention, a method for voiding delivery requests in a pull period 2, is disclosed. According to the embodiment, user devices 540a . . . n also have a potential ability to pull delivery pieces by voiding the delivery request after pull period 1 ends. A period in which delivery may potentially be cancelled is termed pull period 2. Attempts to cancel deliverables during pull period 2 are governed by the following exemplary time chart:

| | |
|---|---|
| 03:00 CT | All next-actions/documents will have been fully |
| | processed, and the corresponding delivery pieces are |
| | sent to a critical delivery processor. |
| 03:00-10:00 CT | All delivery pieces are batched and awaiting processing |
| | and delivery. User can pull orders from this batch with |
| | a high degree of certainty that the order will not go |
| | out, provided that the delivery piece has not been |
| | combined with other delivery pieces to the same |
| | recipient, in which it cannot be pulled/cancelled. |
| 10:00 CT | Critical delivery processing begins and batch delivery |
| | pieces delivered. |
| 10:00-15:00 CT | User device may request to be able to pull orders, |
| | dependent upon whether the particular delivery piece |
| | has actually been delivered, but this ability is not |
| | guaranteed. |
| 15:00 CT | All delivery pieces have been delivered. The user |
| | device cannot request to cancel or pull any orders in |
| | the system. |

According to an embodiment of the invention, “always ready” delivery batches for non-monthly notice documents is disclosed. According to the embodiment, an ability to electronically batch delivery documents and/or place documents in a delivery queue in which the delivery documents sit whereby delivery documents are capable to be pulled until a final timed release for delivery may not be limited to monthly notices. Upon accepting/ordering a next-action/document from items of next-action queue 510, a user has the ability to put that next-action/document into an “always ready” state. The associated document would then be processed and put into a delivery hold to be released for actual delivery at a predetermined time. Until the pre-determined time has elapsed, first user device 540a may “pull” or cancel the delivery piece associated with the always ready document pursuant to guidelines substantially similar to those described above.

According to an embodiment of the invention, cancellation reason tracking and reporting is disclosed. According to the embodiment, when a next-action/document is presented to first user device 540a from next-action queue 510, first user device 540a is given an option to select accept/order the next-action/document, deny/cancel the next-action/document, or pause making such decision until a later time. If first user device 540a elects to deny/cancel the next-action/document, next-action queue 510 requests a reason for the option from first user device 540a. For all denied/cancelled next-action/documents next-action queue 510 tracks an associated user device 540a . . . n that made provided the option, and the reason for the selected option. This enables next-action queue 510 to track A/R performance of a plurality of project objects or specific next-actions/documents associated with each reason (for example, cancellation reason), and produce reports related to same. This allows users to see how cancelled or accepted next-actions/documents affect A/R performance. In some embodiments, reporting server 513 records all interactions between components of environment 500 and stores associated records in reporting database 514.

### DETAILED DESCRIPTION OF EXEMPLARY EMBODIMENTS

In some embodiments, deadline calculator 512 may use a variety of methods to calculate and determine construction notice, lien, or bond claim deadlines and requirements. Accordingly, in a the use of certain interaction information (including, at least, default settings within user configuration database 504, document rules database 505, and other existing data) to supplement data received from plurality of user devices 540a . . . n, which may enable components of system 501 to better understand the characteristics of a subject construction project (herein referred to as, “project” or “project record”), and therefore, make a more accurate calculation or determination of the lien or bond claim compliance requirement.

Accordingly, it is relevant to consider the universe of data that may apply to a construction project and may not be available or accessible to a system calculating or determining compliance needs.

First, the type of construction project, hereinafter referred to as “project type.” The parlance of the construction industry leaves the “project type” rather undefined, as projects are referred to by a variety of informal labels: school project, road project, federal job, state job, county job, city job, private job, public job, public work, residential job, commercial job, industrial job, and so on. Likewise, the parlance among legislators and jurists are no more organized, as projects are separated into new residential, existing residential, commercial, owner occupied residential, state, county, transportation, federal, and so on. Accordingly, it is common for the “project type” label needed to make a compliance determination to be unknown or unavailable from the knowledge or data available to a construction project participant.

Second, the user's role in a construction project, hereinafter referred to as “user role.” The role that a project participant plays in a construction project is very important to determine the compliance requirements for that party. Again, parlance is unregulated on a construction job, evidenced by the fact that a contracting party who contracts with the property owner may be referred to as a general contractor, prime contractor, direct contractor, GC, contractor, and more. The role of a party is critical to compliance determinations because different jurisdictions (for example state government and the federal government) may regulate parties differently depending on their “role” in a project, which is typically defined by each applicable jurisdiction statute. Roles may include general contractor, subcontractor, sub-subcontractor, sub-sub-subcontractor, supplier, equipment less, and so on.

Third, and similar to the user role is the hired-by role of a party on a project, hereinafter referred to as a “hired-by role.” While the “user role” identifies the role of the system user on a project, the “hired-by role” identifies the role of the project participant who hired the user. This is important because laws oftentimes distinguish on compliance requirements depending on the role of the party that hired a participant, and further, by the “tier” of a party within the contracting chain. It is possible to substitute “hired-by role” for the identification of a tier, and vice versa, and sometimes, depending on the circumstances, even the “user role.” Nevertheless, it is common for the participants and the systems they employ to lack any identification of the “role” of their customer.

Fourth, critical triggering dates, hereinafter referred to as “dates” or “trigger dates.” Dates are data elements critical to the function of determining or calculating a deadline, by deadline calculator 512, to perform a compliance action, as a compliance action likely is required within a certain period of time that beings to run upon the happening of a trigger date. Project management system, accounting systems, ERPs, and other software platforms typically track dates like the date of invoice or date of opening an account. They do not, however, track the dates specifically required by the various jurisdiction statues (for example, state and federal statutes). Again, these statutory dates are labeled different and are substantially different depending on jurisdiction and circumstance. Accordingly, it is common for project participants and the systems they employ to lack any identification of the dates necessary for a calculation or determination of compliance items.

According to an embodiment of the invention, system user preferences to establish defaults is disclosed. According to the embodiment, part A outlines some of the common data missing, unknown, or unattainable about a construction project that may be required by a system, method, or process to perform some calculation of mechanic's lien or bond claim compliance requirements. This Part B details a method and process for system users to establish certain data defaults within a system 501.

A preferred embodiment of the invention, discloses a method to enable user devices 540a . . . n to establish data defaults within associated records in user configuration database 504, that may or may not be dependent on rules and circumstances, which will be used for the purpose of performing a process, through system 501, to analyze defaults, and other existing data, as further explained in Parts C and D of this detailed description, to supplement missing information to complete known data about a construction project record, enabling system 501 to calculate and determine bond and lien claim deadlines.

In line with the four items discussed in the above part A, which is likely to be missing about a construction project record, some embodiments contemplate that user devices 540a . . . n of system 501 may, through any method, process, or system of creating “rules,” which are commonly referred to as “if” and “then” rules, or “if this then that” rules, create rules and defaults associated to a corresponding user device 504a . . . n whereby defaults may be stored in user configuration database 504 and rules may be stored in rules database 502.

Frequently missing items (as discussed in Part A) may establish exemplary rules for user devices 540a . . . n as follows:
Default project type for all projects
Default project type when a project is in a certain jurisdiction, county, city or postal code
Default project type whenever project is associated with a certain location, branch, user account, etc.
Default user role for all projects
Default user role when a customer is a certain party;
Default user role when a project is associated with a certain location, branch, user account, etc.
Default hired-by role for all projects
Default hired-by role when a customer is a certain party;
Default hired-by role when a project is associated with a certain location, branch, user account, etc.
Default dates are entered by calculating days from previously entered dates, or other date records within the data available
Default dates based on hired-by parties
Default dates for all projects

According to an embodiment of the invention (part C), a system and method for using established defaults and existing data to supplement missing information, is disclosed.

Part A above outlines some of the common data missing, unknown, or unattainable about a construction project that may be required by system 501 and associated methods or processes to perform some calculation of mechanic's lien or bond claim compliance requirements. Part B above explains how a user devices 540a . . . n may be enabled to establish certain data defaults within system 501 to dictate how certain missing data is supplemented.

Part C discloses data available to system 501, as contemplated herein, that can be examined for relevance related to individual records inputted into system 501 by one or more user devices 540a . . . n, and outlines a method using both the default data from Part B, supra, and system data, to supplement data from first user device 540a about a construction project to enable rules engine 506 to calculate or determine a compliance requirement.

According to the embodiment, first user device 540a is capable to establish data defaults, that may or may not be dependent on rules and circumstances, and to supplement those defaults with certain known data, which, together, will be used for the purpose of analyzing the defaults, and other existing data, to supplement missing information to complete known data about a construction project record, enabling deadline calculator 512 to calculate and determine bond and lien claim deadlines and may comprise the following method.

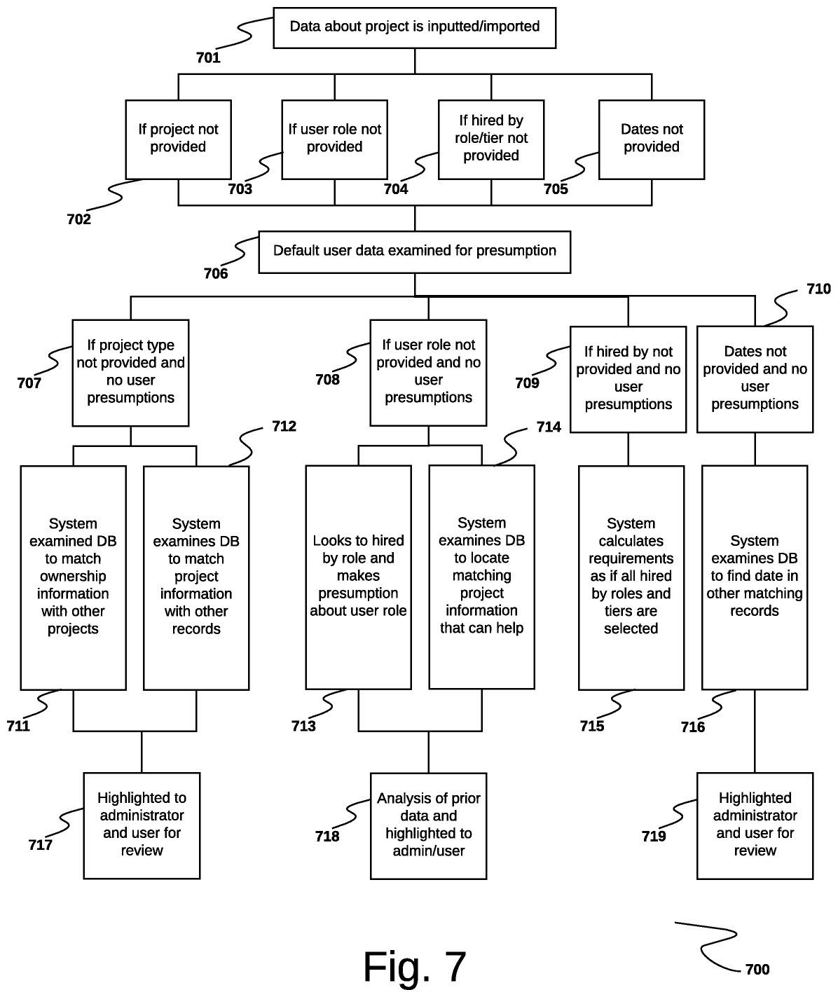

Referring now to FIG. 7, FIG. 7 is a flow diagram illustrating an exemplary method whereby upon certain information being missing from a project record, it is supplemented with user default data, or if not available, presumptive data, to calculating a deadline or requirement.

According to the embodiment, in a first step 701 Identifying, by object manager 516, data needed to make a calculation and data available for the calculation, by performing the following steps: in next steps 702 to 705, examining, by deadline manager 512, a deadline or requirement calculation methodology, and extracting data elements required to perform the calculation, including any data elements that are not required but can be used to assist in or improve the calculation; in step 702, examining, by object manager 516, if project object 610 subject to the calculation or determination task, and extracting data elements contained within or association with a subject project record is provided by first user device 540a that may be required to perform or improve, the calculation; in a next step 703, identifying, if user role 615 is provided; in a next step 704, identifying if hiring user 616 is provided, in a next step 705, identifying if date 653 via an associated document object 650 is provided. In essence, by comparing the data extracted from the steps above, one or more “missing data” is identified.

In a next step 706, examining, by the deadline calculator 512, user configuration database 504 has any defaults established and associated with first user device 540a's record, for the purposes of supplementing the “missing data.” IN a next step, if a default record matching the “missing data” is associated with first user device 540a and contains associated rules in rules database 502 for its applicability, then a determination of if the rules are met and the default record applies id performed, and if so, the default record as usable for supplementation. If a default record matching the “missing data” is associated with first user device 540a and does not contain rules for applicability of the default record as usable for supplementation then if, through the process explained in the above steps usable default data is located by deadline calculator 512, which will match and supplement certain “missing data,” then this method will create, by the computer or computer program, a record of the supplemental data for first user device 540a, as it relates to project object 610 and the function of calculating or determining lien and bond claim compliance requirements; and, examining whether any “missing data” remains, and if so, to continue to step 706. If not, and all missing data is fulfilled by the method up to this point, then the method of calculating or determining the compliance requirements shall be performed utilizing first user device 540a standard data as stored in user configuration database 504, and the supplemented data based on defaults;

In next steps 707 to 710, object manager 516 examines “missing data” remaining after performing the previous steps, and thereafter, looking to objects 600 to make presumptions that can supplement missing data, depending on the data type. In a next step 707, if the missing data includes, at least, the “project type,” object manager 516 may perform one or more than one of the following steps: step 711 determine whether the subject project object 610 is associated with information about ownership of the subject project, and if so, to examine the system's entire universe of data, whether stored within a database, data source, or otherwise, and extract any other project records associated with the same project owner, and for those located projects to further extract an associated project type identifier(s) assigned to those projects; and/or Examine, in step 712, the system's entire universe of data, whether stored within a database, data source, or otherwise, to extract, by the object manager 516, any other project records that are substantially similar to the subject project record, and if such projects are located, to extract one or more project type identifiers assigned to those projects; and/or, examine, by deadline calculator 5122, whether the subject project record is associated with information about ownership the subject project, and if so, to examine the name of the subject project owner and determine whether it is contains any “white label” identifiers which may suggest a project type; regarding the “white label” identifiers whereby list of white label identifiers would be established and stored within the user configuration database, and may be established as unique to each user device 540a . . . n registered in user configuration database 504, and/or applicable system-wide; and, whereby white label identifiers are key characters or character strings that, when appearing within a name of a project owner, would strongly indicate a certain project type. For example, the terms “Inc.” and “Incorporated” in an owner name would strongly indicate a commercial project type, but a term like “US Army Corps of Engineers,” or “USAGE” would strongly indicate a federal project type. If, after examination by deadline calculator 512, a white label identifier is located within the project record's affiliated owner, to extract, by the computer or computer program, the project type identifier(s) affiliated with the identified white label. Further, determine, by object manager 516, a presumption project type by performing the following: collecting, by object manager 516, the project type identifiers extracted from the above process by object manager 516; and, comparing, by object manager 516, those identifiers, and determining if they are all the same, or if any are unique; and, if all of the project identifiers are the same, using the associated project type as a “presumptive” project type, and if there are no results, or if the results conflict with one another, then to not create presumptive project type. In a next step 717, send an alert to administrator user device 540c and user device 540a for review.

In a next step 708, upon the missing data being the “user role,” object manager 516 performs one or more than one of the following processes: In step 714, examine the system's entire universe of data, whether stored within a database, data source, or otherwise, and to extract any other project records that are substantially similar to the subject project record, and if such projects are located, to extract, whether first user device 540a appears to be associated with that project record in any way, and if so, then to extract the user role identifier(s) assigned to the user for that project; and/or, in step 713, examine the subject project record and determine if the record contains a reference to the system user's “hired-by role” for the subject project, and if so, then to calculate, by the computer or computer program, the user role based thereupon, using a formula set in the computer database or script that assigns presumptive user roles based on hired-by roles, such as, that when the hired by role is property owner the presumptive user role is general contractor, or as another example, when the hired by role is general contractor, the presumptive user role is subcontractor, and to extract, the user role identifier that results from that calculation. Further, examine the system user's universe of associated projects within the system data, stored within a database, data source, or otherwise, and to extract the user role on each of the projects therein, and to determine if a specific user role identifier repeats for the user more than a predefined rate of times, for example, 90% of the time, and if so, to extract that repeating user role identifier; and/or determine a presumption user role by performing the following: collecting, by the computer or computer program, the user role identifiers extracted from the above process; and comparing those identifiers, and determining if they are all the same, or if any are unique; and if all of the user role identifiers are the same, using the associated user role as the “presumptive” user role. If there are no results, or if the results conflict with one another, then to not create presumptive user role.

In step 709, when the missing data is the “hired by role,” examining, in step 715, the universe of data, stored in a database, data source, or otherwise within the computer program, and extracting every possible hired-by role identifier, and then creating a presumptive hired by role equal to all possible hired by roles. In step 718, an analysis of prior data and are highlighted to administrator user device 540c and first user device 540a.

In step 710, when the missing data is a specific date or trigger date, performing one or more of the following processes: Examine, in step 716, by object manager 516, the system's entire universe of data (that is, all data in databases 502 to 505 or any external data sources, such as data receivable from law server 532 and/or other service 531), whether stored within a database, data source, or otherwise, and to extract any other project records that are substantially similar to the subject project record, and if such projects are located, to extract all date records associated therewith. For this method, date records are associated with project objects 610, contain a record of the date, and also contain some association with a descriptor for associated document objects 650, with some associative data element distinguishing between those dates that “individually” relevant to project object 610, and those dates that are “project wide” or “master dates.” A project wide date is a date that is not unique to the particular user device 540, but instead, is applicable to all user devices 540a . . . n that are associated with a project object 610. In an examination, deadline calculator 512, of the dates associated with substantially similar projects, all associated “project wide dates” date records may be extracted; and/or, examine first user device 540a's universe of associated projects within the system data, stored within a database, data source, or otherwise, and to extract an average date (related to the missing date) for projects, within the user's data, that may be similar to project object 610; and/or, determine a presumption date by performing the following: Collecting, by object manager 516, the date(s) extracted from the above steps; and, determining, by object manager 516, if the dates discovered will satisfy the missing dates data for the subject project; and/or, comparing, by object manager 516, the discovered dates with one another, to the extent they are the same date type, and determining if they are all within a predefined proximity (as calculated by proximity calculator 511), for example, five (5) day period of each, or if any are not within a pre-specified range; and if all of the dates are within the five (5) day period range, using an associated date as a “presumptive” date, and if they are outside of pre-specified range, then to not create presumptive date.

In some embodiments, a collection, by object manager 516, of all of the subject project record data, qualifying default data, and qualifying presumptive data, all of which applies to a method and system—of any sort—to calculate or determine, by a deadline calculator 512, mechanics lien or bond claim deadlines and requirements, and to utilize, by aggregator 507 all of that date to perform the calculation function.

In some embodiments, communication of errors, incomplete functions, and augmentations to user devices 540a . . . n to enable user management, oversight, and supplementation on some occasions, the process and method outlined in various embodiments of the invention will be successful at supplementing missing information adequately enough for deadline calculator 512 to calculate or determine deadlines or requirements with originally inadequate information. Furthermore, employment of this method may sometimes create scenarios when the missing data can be supplemented without ambiguity.

In some embodiments, where there may be a problem in acquiring all of the missing data, where acquiring missing data not be completely unambiguous; and that may result in situations where supplemented data may conflict or is otherwise uncertain, and a presumptive date may not result, a mechanism whereby missing, augmented, erroneous, or ambiguous data is highlighted within system 501 is disclosed. According to the embodiment, an administrator user device 540b and/or first user device 540a may be notified in steps 717 to 719 based on corresponding circumstances of method 700. In this regard, examining, by object manager 516, a system's project records that are subject to a process and method—of any type—of calculating or determining, by deadline calculator 512, mechanics lien or bond claim deadlines, and of creating indicators for certain data that affect or deserve caution in the calculation or determination process, comprising of the following steps:

Identifying, by object manager 516, the data needed to make a calculation and the data available for the calculation, by performing the following steps: examining, by deadline calculator 512, the deadline or requirement calculation methodology, and extracting the data elements required to perform the calculation, including any data elements that are not required but can be used to assist in or improve the calculation; examining, by object manager 516, the project object 610 subject to the calculation or determination task, and extracting the data elements contained within or association with the subject project object 610 that are required to perform, or will improve, the calculation; identifying, by object manager 516, by comparing the data extracted from the steps above, which data can be utilized and missing and establishing replacement data, by aggregator 507, and process as the “missing data;” examining, by first user device 540a, any default data or presumptive data that was obtained through the process described previously, supra, and comparing that data with the “missing data” extracted, and identifying, by object manager 516, what data remains missing. Extracting, by object manager 516, all of the missing data, and displaying, to first user device 540a, a record of the data that is missing, and receiving, from first user device 540a, the missing data, which when performed, would enable deadline calculator 512 to calculate or determine a mechanics lien or bond claim compliance requirements for project object 610.

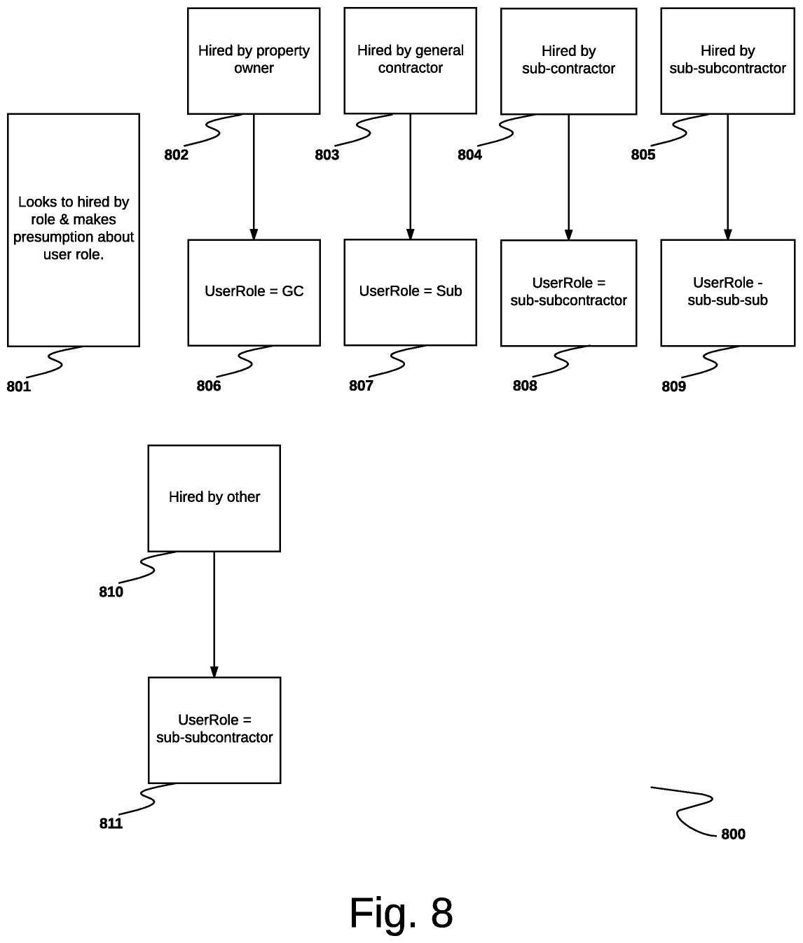

FIG. 8 is a flow diagram illustrating an exemplary method of assigning presumptive data about a user role according to a preferred embodiment of the invention. According to the embodiment, in a first step 801, object manager 516 examines hired by role and makes a presumption about user role. Accordingly, in step 802, hired by property owner is assigned as UserRole=GC of step 806. In step 803 hired by general contractor is assigned as UserRole=Sub of step 807. In step 804, hired by sub-contractor is assigned as UserRole=sub-subcontractor in step 808. In step 805 hired by sub-subcontractor is assigned as UserRole—sub-sub-sub of step 809. In step 810, hired by other is assigned as UserRole=sub-subcontractor of step 811.

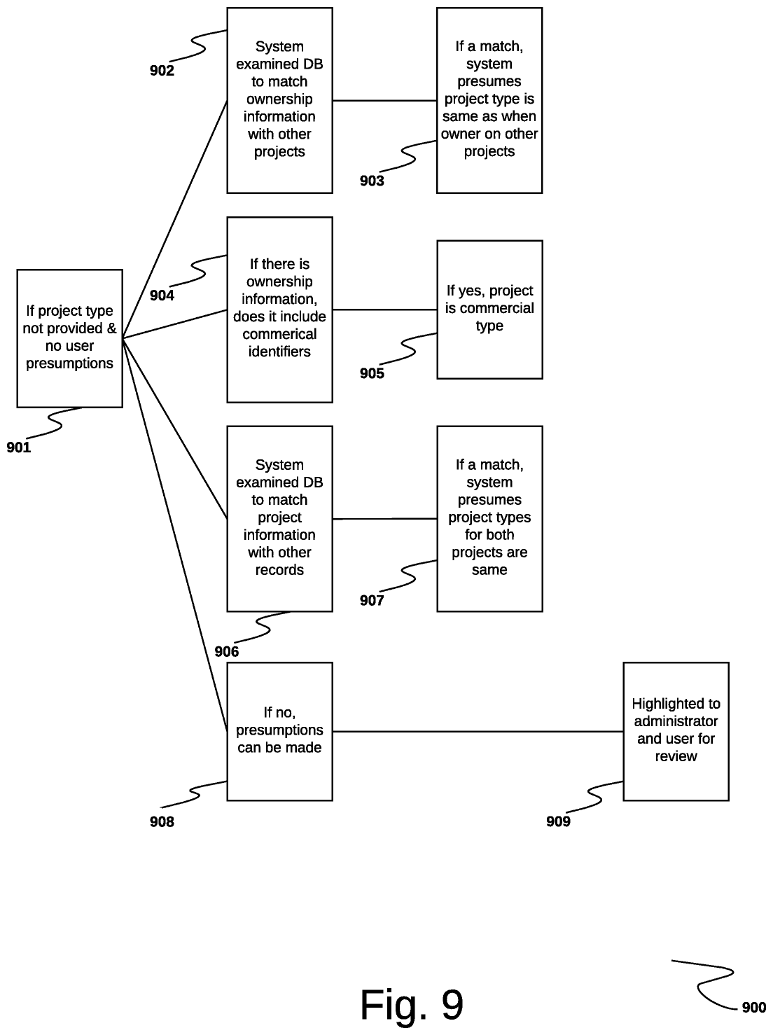

FIG. 9 is a flow diagram illustrating a method if a project type is not provided and no user presumptions. In a first step 901, If project type is not provided and no user presumptions are made, one or more of steps 902 to 908 will follow. In a following step 902, object manager 516 examines DB to match ownership information with other projects. If there is a match, object manager 516 presumes, in step 903, that an associated project type is same as owner on other projects. In step 904, object manager 516 attempts to determine if there is ownership information, and if it includes commercial identifiers. If yes, object manager 516 assigns a type 613 as commercial type. In step 906, object manager 516 examines databases of system 501 to match project information with other records, if there is a match, object manager 516 presumes, in step 907, project types are the same for both projects. In step 908, If no presumptions can be made, then, in step 909, administrative user device 540c and/or first user device 540a.

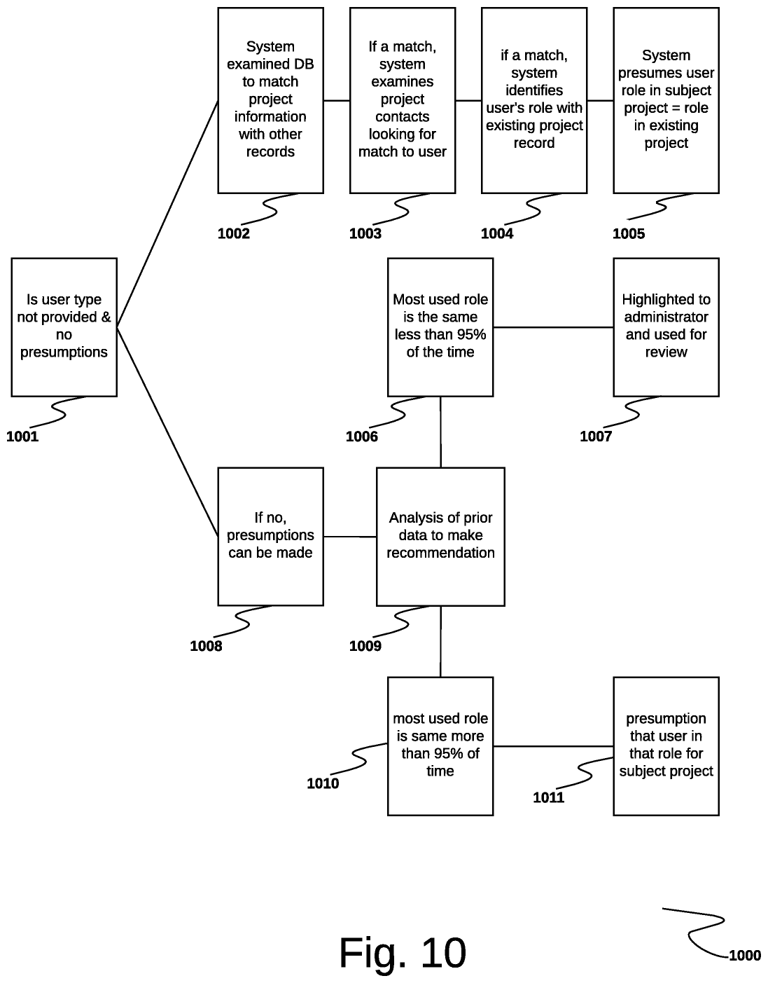

FIG. 10 is a flow diagram illustrating an exemplary method for when a user type is not provided and comprise no presumptions. In a first step 1001, upon a user type not being provided and no presumptions then in a next step 1002, object manager 516 examines databases of system 501 to match project information with other records. In a next step 1003, if there a match, object manager 516 examines project contacts looking for match to user. In a next step 1004, if a match, system identifies user's role with existing project record, then, in a next step 1005, object manager 516 presumes user role 615 in project object 610 is the role in the existing project. In a next step 1008, If no, presumptions can be made, in step 1009, analysis of prior data is made to make recommendation. In step 1006, the most used role is the same if less than 95% of the time and, in step 1007, a notification is sent to administrator user device 540c and/or first user device 540a. Otherwise, in step 1010, most used role is same more if than 95% of time and a presumption that user in that role for project object 610 in a final step 1011.

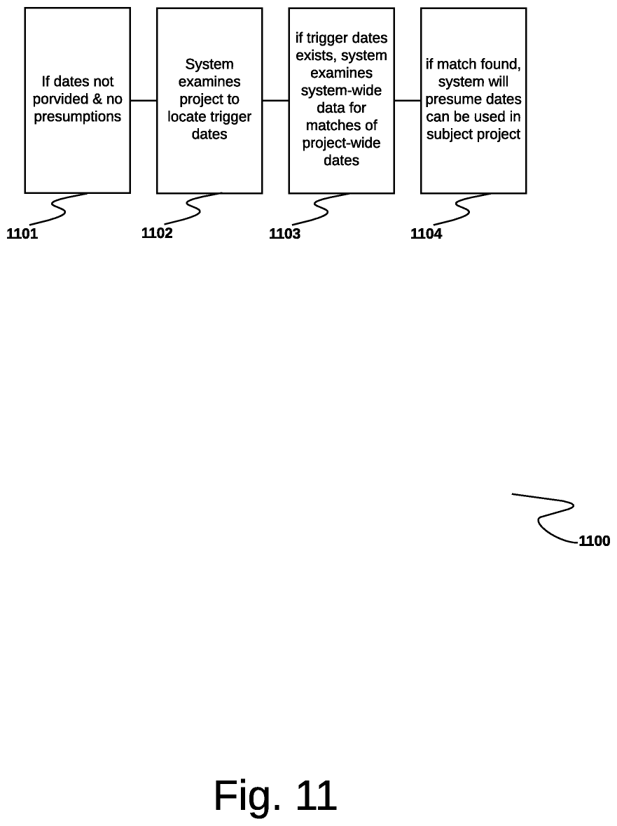

FIG. 11 is a flow diagram illustrating an exemplary method for when dates are not provided and no presumptions are made, according to a preferred embodiment of the invention. According to the embodiment, in a first step 1101, if dates not provided and no presumption are calculated, object manager 516 examines project object 610 for one or more associated trigger objects 620. If one or more trigger objects 620 exist, then object manager 516 examines, in step 1103, system 501 data for matches of project-wide dates. if match found, in step 1104, object manager 516 will presume associated dates can be used in project object 610 (and associated objects 600).

It should be appreciated that methods 700 through 1100 may happen iteratively through all available documents to populate next-action queue 510

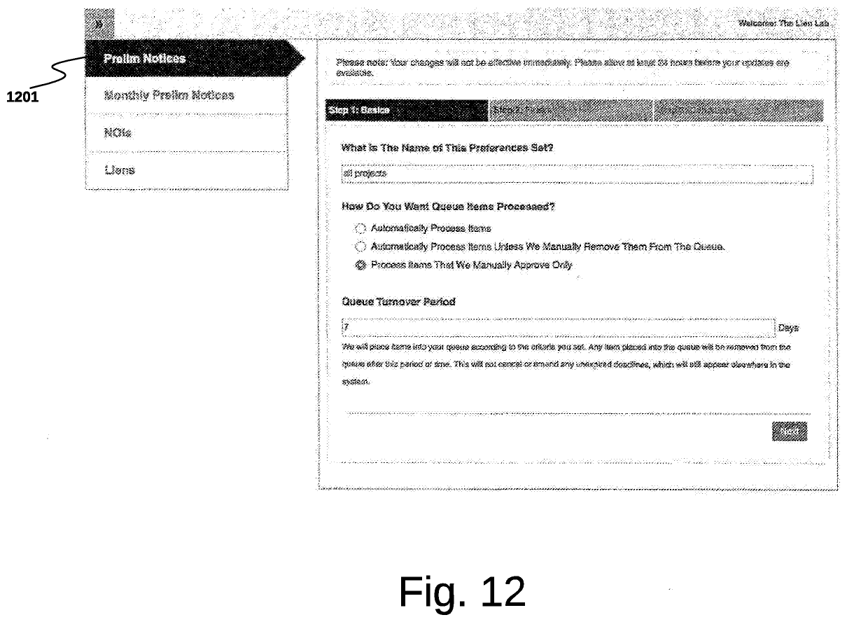

FIG. 12 is an illustration of exemplary workflow settings for a user device, according to a preferred embodiment of the invention. For example, in this figure, the “Prelim Notices” 1201 workflow is selected. In this regard, first user 540a is on Step 1: Basics in determining how queue items should be processed by the system, and how long items should remain in the queue awaiting potential manual action.

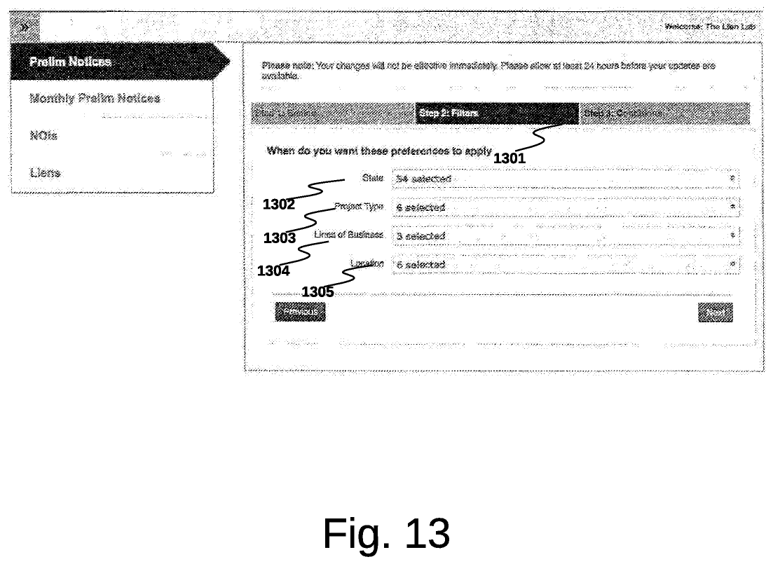

FIG. 13 is an exemplary illustration of a plurality of filters customizable by a user device, according to a preferred embodiment of the invention. Interface 1300 illustrates filters 1301 by which the user may customize next-action queue 510 by defining which specific project objects 610 should be considered by the queue workflow settings. As seen here, the user may select from one of 54 jurisdictions (for example, “states”) in jurisdiction field 1302 (for example, including D.C. and some U.S. territories of the USA), 6 different project types in project type field 1303, and between any line of business 1304 and/or location 1305 that the user has created in the user's account.

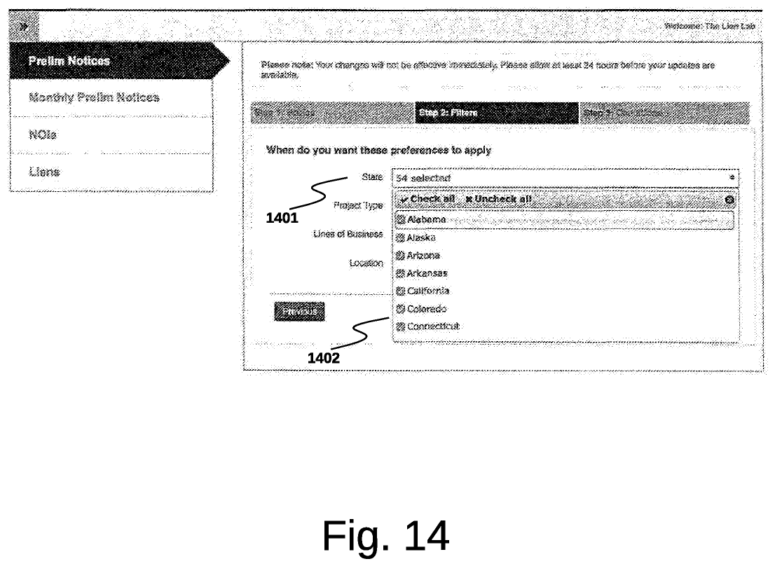

FIG. 14 is an exemplary illustration of user selectable jurisdictions, according to a preferred embodiment of the invention. According to the embodiment, a detailed additional view showing the dropdown menu 1402 from which the user can select the jurisdictions 1401 to which the specific workflow object 630 settings should be applied is shown. If a jurisdiction is checked off, the system understands that it is to be included in next-actions/documents driven to the queue in conjunction with the conditions. Further, checking off the particular jurisdiction informs the system that deadline calculator 512 calculated legal deadlines for an associated jurisdiction should be applied to potential next-actions/documents for that state in conjunction with the conditions of a workflow associated to next-action queue 510 in order to determine which next-actions/documents should be populated into next-action queue 510.

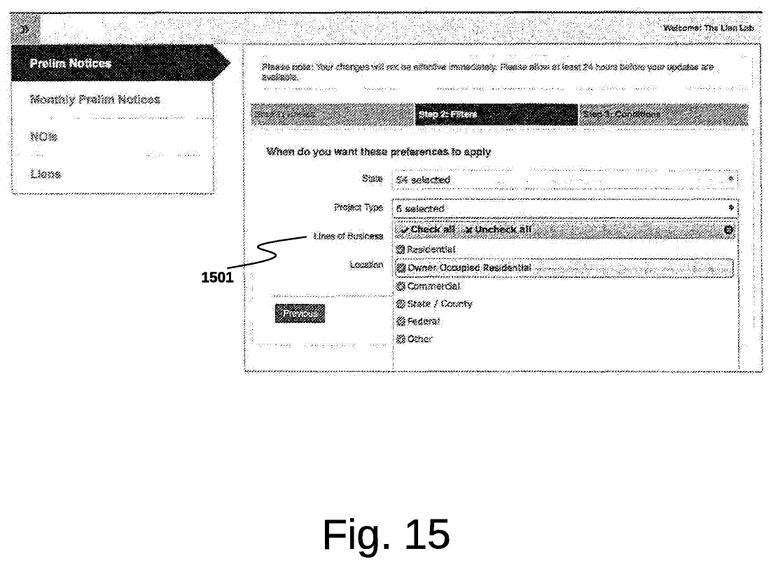

FIG. 15 is an exemplary illustration of user selectable project types, according to a preferred embodiment of the invention. According to the embodiment, a view showing a dropdown menu from which the user can select a specific project type of a plurality of project types to which the specific queue workflow setting object 645 should be applied. If a project type 1501 is checked, system 501 understands (as described above) that next-actions/documents associated with a particular project type (as selected) whose project type 613 match, are to be included in next-actions/documents driven to next-action queue 510 in conjunction with conditions 648. Further, checking a particular project type 1501 informs system 501 that deadline calculator 512 calculated legal deadlines for that particular project type (for the jurisdictions already selected pursuant to FIG. 14) should be applied to potential next-actions/documents in conjunction with conditions 648 of an associated workflow settings object 645 in order to determine which next-actions/documents should be populated into next-action queue 510.

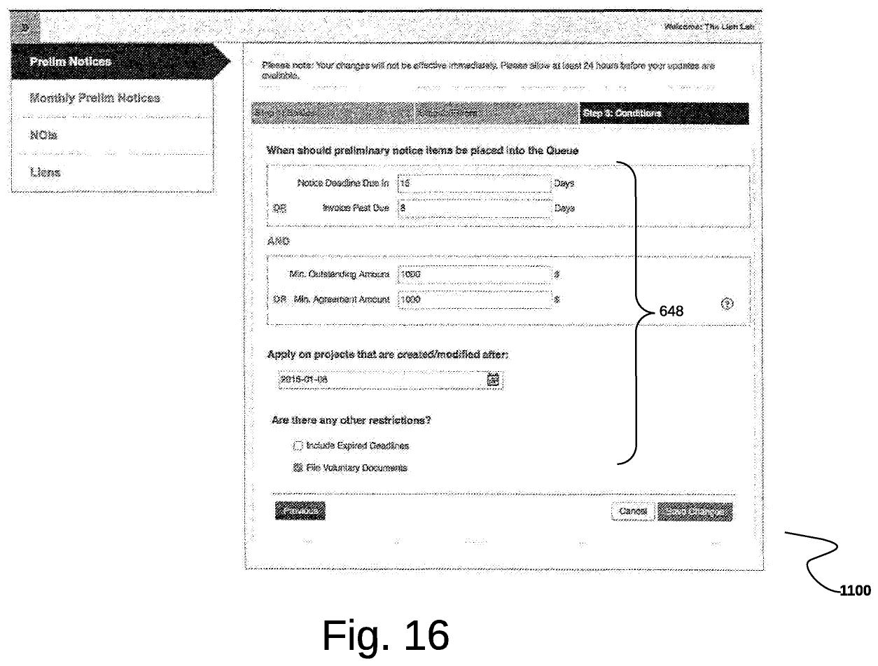

FIG. 16 is an exemplary illustration of user device control of queued documents, according to a preferred embodiment of the invention. According to the invention, interface 1600 shows conditions 648 by which a user device 540a . . . n can exert more specific control over document objects 650 driven into next-action queue 510. For example, conditions 648 allow a first user device 540a to configure population of next-action queue 510 based on system-calculated legal deadline 639 for the particular document type 652 (for example, “notice deadline due in x days”), or by the amount of time, as calculated by proximity calculator 511, that an invoice is past due (for example, “invoice past due y days” provided first user device 540a syncs associated information with system 501), or by the sooner of either. Further, first user device 540a may choose to only have system 501 determine applicable next-action/products into next-action queue 510 when either, for example, an amount outstanding or an original agreement amount meet or exceed some user-provided threshold configured in user configuration database 504. Finally, conditions 648 allow first user device 540a to set a date from which conditions 648 may begin to function, and choose by checkbox whether to include next-actions/documents in next-action queue 510 that either have expired deadlines 639 as calculated by deadline calculator 512, or are voluntary documents as calculated by system 501.

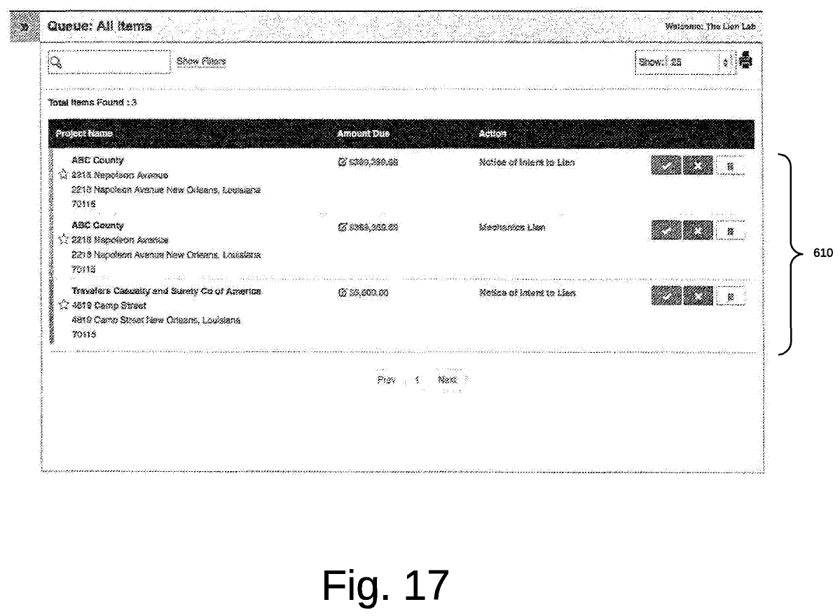

FIG. 17 is an exemplary illustration of a populated next-action queue, according to a preferred embodiment of the invention. According to the embodiment, one or more projects objects 610 that match requirements set forth by first user device 540a are displayed to first user device 540a as an easily manageable list 1701. From list 1701, next-action queue 510 may receive a command from first user device 540a that may take actions on project objects 610 associated to next-action queue 510; actions may include, but are not limited to, accept/order a next-action/document, deny/cancel a next-action/document, or pause action/document.

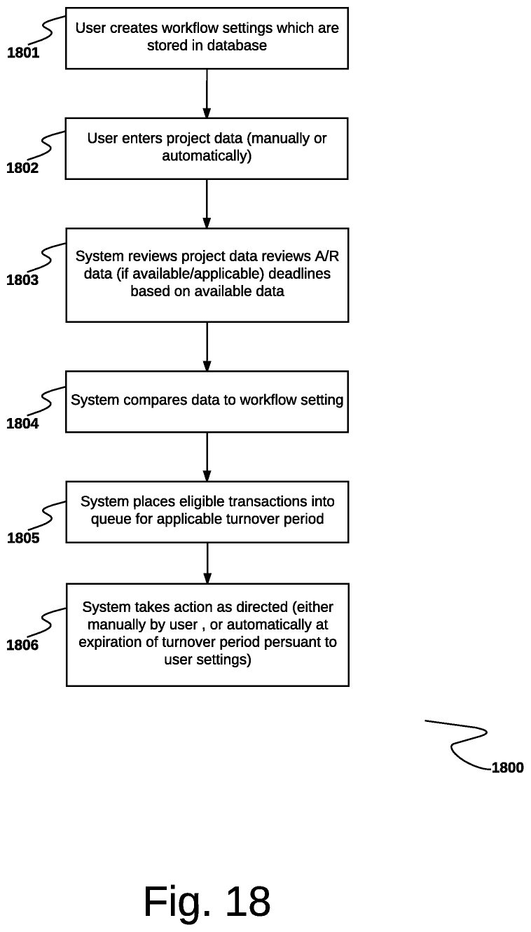

FIG. 18 is an exemplary illustration of a queue process, according to a preferred embodiment of the invention. According to the embodiment, in a first step 1801, a first user device 540a creates workflow settings which are stored in workflow database 503. In a nest step 1802, project object 610 receives project data, via object manager 516, from first user device 540a and is stored in user configuration database 504 and reporting database 514. In some embodiments, rules engine 506, deadline calculator 512, object manager 516, and other components of system 501 complement missing data as described previously. In a next step 1803, reporting server 513 reviews A/R data (if available/applicable) deadlines based on historically captured data. In a next step 1804, object manager 516 compares data to an associated workflow settings object 645. In a next step 1805 system 501 places eligible transactions into next-action queue 510 for an applicable turnover period. In a final step 1806, system takes action as directed by first user device 540a, or automatically at expiration of turnover period pursuant to user settings, as calculated by proximity calculator 511.

The skilled person will be aware of a range of possible modifications of the various embodiments described above. Accordingly, the present invention is defined by the claims and their equivalents.

1. A computing system comprising:
at least one processor;
a non-transitory computer-readable medium; and
program instructions stored on the non-transitory computer-readable medium that are executable by the at least one processor such that the computing system is configured to:
access project data for a construction project, wherein the project data comprises a plurality of data fields including a first data field for a type of the construction project, a second data field for a location of the construction project, and a third data field for a user role of a user associated with the construction project;
detect a trigger event based on a predetermined amount of time elapsing after submission of a past due invoice for, or completion of, at least a portion of the construction project;
based on detecting the trigger event, access a database comprising a plurality of documents for creating, managing, or enforcing a mechanic's lien, wherein each document of the plurality of documents is associated with data representing (i) a jurisdiction where the document applies, (ii) a submitter role of a party that is allowed to submit the document, and (iii) timing information indicating when the document is allowed to be submitted;
identify a particular document in the database based on the particular document being associated with data representing (i) a particular jurisdiction that matches the location of the construction project, (ii) a particular submitter role that matches the user role of the user associated with the construction project, and (iii) particular timing information indicating that the particular document is currently allowed to be submitted; and
cause a client station of the user to display an indication of the particular document for presentation to the user.

2. The computing system of claim 1, further comprising program instructions stored on the non-transitory computer-readable medium that are executable by the at least one processor such that the computing system is configured to:
determine that at least one of the first, second, or third data fields is missing data;
compare at least some of the project data for the construction project to historical project data for historical construction projects to identify a particular historical construction project that shares one or more characteristics with the construction project; and
assign data from the particular historical construction project to the at least one of the first, second, or third data fields that is missing data.

3. The computing system of claim 1, wherein the plurality of data fields further includes a fourth data field for a hired-by role indicative of a role of a party that hired the user associated with the construction project, and wherein the computing system further comprises program instructions stored on the non-transitory computer-readable medium that are executable by the at least one processor such that the computing system is configured to:
determine that the third data field for the user role is missing data; and
assign particular user role data to the third data field based on data in the fourth data field for the hired-by role.

4. The computing system of claim 1, wherein detecting the trigger event further comprises detecting the trigger event based on an amount of the past due invoice exceeding a threshold amount.

5. The computing system of claim 1, wherein the first data field comprises data indicating that the type of the construction project is one or more of: residential, commercial, industrial, private work, public work, city work, county work, state work, or federal work.

6. The computing system of claim 1, wherein the third data field comprises data indicating that the user role of the user of the construction project is one or more of: general contractor, subcontractor, sub-subcontractor, sub-sub-subcontractor, or supplier.

7. The computing system of claim 1, wherein the particular document of the plurality of documents for creating, managing, or enforcing a mechanic's lien comprises a preliminary notice document, a mechanic's lien claim document, a mechanic's lien extension document, or a mechanic's lien foreclosure document.

8. A method comprising:
accessing project data for a construction project, wherein the project data comprises a plurality of data fields including a first data field for a type of the construction project, a second data field for a location of the construction project, and a third data field for a user role of a user associated with the construction project;
detecting a trigger event based on a predetermined amount of time elapsing after submission of a past due invoice for, or completion of, at least a portion of the construction project;
based on detecting the trigger event, accessing a database comprising a plurality of documents for creating, managing, or enforcing a mechanic's lien, wherein each document of the plurality of documents is associated with data representing (i) a jurisdiction where the document applies, (ii) a submitter role of a party that is allowed to submit the document, and (iii) timing information indicating when the document is allowed to be submitted;
identifying a particular document in the database based on the particular document being associated with data representing (i) a particular jurisdiction that matches the location of the construction project, (ii) a particular submitter role that matches the user role of the user associated with the construction project, and (iii) particular timing information indicating that the particular document is currently allowed to be submitted; and
causing a client station of the user to display an indication of the particular document for presentation to the user.

9. The method of claim 8, further comprising:
determining that at least one of the first, second, or third data fields is missing data;
comparing at least some of the project data for the construction project to historical project data for historical construction projects to identify a particular historical construction project that shares one or more characteristics with the construction project; and
assigning data from the particular historical construction project to the at least one of the first, second, or third data fields that is missing data.

10. The method of claim 8, wherein the plurality of data fields further includes a fourth data field for a hired-by role indicative of a role of a party that hired the user associated with the construction project, and wherein the method further comprises:
determining that the third data field for the user role is missing data; and
assigning particular user role data to the third data field based on data in the fourth data field for the hired-by role.

11. The method of claim 8, wherein detecting the trigger event further comprises detecting the trigger event based on an amount of the past due invoice exceeding a threshold amount.

12. The method of claim 8, wherein the first data field comprises data indicating that the type of the construction project is one or more of: residential, commercial, industrial, private work, public work, city work, county work, state work, or federal work.

13. The method of claim 8, wherein the third data field comprises data indicating that the user role of the user of the construction project is one or more of: general contractor, subcontractor, sub-subcontractor, sub-sub-subcontractor, or supplier.

14. The method of claim 8, wherein the particular document of the plurality of documents for creating, managing, or enforcing a mechanic's lien comprises a preliminary notice document, a mechanic's lien claim document, a mechanic's lien extension document, or a mechanic's lien foreclosure document.

15. A non-transitory computer-readable storage medium having program instructions stored thereon that are executable to cause a computing system to:
access project data for a construction project, wherein the project data comprises a plurality of data fields including a first data field for a type of the construction project, a second data field for a location of the construction project, and a third data field for a user role of a user associated with the construction project;
detect a trigger event based on a predetermined amount of time elapsing after submission of a past due invoice for, or completion of, at least a portion of the construction project;
based on detecting the trigger event, access a database comprising a plurality of documents for creating, managing, or enforcing a mechanic's lien, wherein each document of the plurality of documents is associated with data representing (i) a jurisdiction where the document applies, (ii) a submitter role of a party that is allowed to submit the document, and (iii) timing information indicating when the document is allowed to be submitted;
identify a particular document in the database based on the particular document being associated with data representing (i) a particular jurisdiction that matches the location of the construction project, (ii) a particular submitter role that matches the user role of the user associated with the construction project, and (iii) particular timing information indicating that the particular document is currently allowed to be submitted; and
cause a client station of the user to display an indication of the particular document for presentation to the user.

16. The non-transitory computer-readable storage medium of claim 15, wherein the program instructions are further executable to cause the computing system to:
determine that at least one of the first, second, or third data fields is missing data;
compare at least some of the project data for the construction project to historical project data for historical construction projects to identify a particular historical construction project that shares one or more characteristics with the construction project; and
assign data from the particular historical construction project to the at least one of the first, second, or third data fields that is missing data.

17. The non-transitory computer-readable storage medium of claim 15, wherein the plurality of data fields further includes a fourth data field for a hired-by role indicative of a role of a party that hired the user associated with the construction project, and wherein the program instructions are further executable to cause the computing system to:
determine that the third data field for the user role is missing data; and
assign particular user role data to the third data field based on data in the fourth data field for the hired-by role.

18. The non-transitory computer-readable storage medium of claim 15, wherein detecting the trigger event further comprises detecting the trigger event based on an amount of the past due invoice exceeding a threshold amount.

19. The non-transitory computer-readable storage medium of claim 15, wherein the first data field comprises data indicating that the type of the construction project is one or more of: residential, commercial, industrial, private work, public work, city work, county work, state work, or federal work, and wherein the third data field comprises data indicating that the user role of the user of the construction project is one or more of: general contractor, subcontractor, sub-subcontractor, sub-sub-subcontractor, or supplier.

20. The non-transitory computer-readable storage medium of claim 15, wherein the particular document of the plurality of documents for creating, managing, or enforcing a mechanic's lien comprises a preliminary notice document, a mechanic's lien claim document, a mechanic's lien extension document, or a mechanic's lien foreclosure document.
